(19) United States
(12) Patent Application Publication
(10) Pub. No.: US 2026/0290629 A1
(43) Pub. Date: Sep. 24, 2026

(54) Advanced Fuel Oscillating Fusion Reactor

(71) Applicant: TIBBAR PLASMA TECHNOLOGIES, INC., Los Alamos, NM (US)

(72) Inventors: Richard A. Nebel, Los Alamos, NM (US); William Loane Gibson, Los Alamos, NM (US); Daniel Karmgard, Los Alamos, NM (US); Walter Lee Davis, Rogersville, MO (US); Keith Robert Moser, Libertyville, IL (US); Pamela A. Paine, Los Alamos, NM (US)

(73) Assignee: TIBBAR PLASMA TECHNOLOGIES, INC., Los Alamos, NM (US)

(21) Appl. No.: 19/288,349

(22) Filed: Aug. 1, 2025

Related U.S. Application Data
(60) Provisional application No. 63/679,249, filed on Aug. 5, 2024.

(51) Int. Cl. G21B 1/21; G21B 1/05

(52) U.S. Cl. CPC G21B 1/21; G21B 1/05

(57) ABSTRACT

A fusion device includes vacuum chamber, a center electrode, electromagnetic coils, memory that stores operational instructions, and processing module(s) operably coupled to the memory and configured to execute the operational instructions. The vacuum chamber has a cylindrical shape and is configured to contain a plasma having elements suitable for nuclear fusion. The and processing module(s) is configured to facilitate generation of vacuum or near vacuum within the vacuum chamber and also to facilitate driving of electric current signal(s) within the electromagnetic coil(s) to generate a magnetic field within the vacuum chamber. The magnetic field is configured to form the plasma into plasma toroid rings and to effectuate the plasma toroid rings to undergo simple harmonic motion axially within the vacuum chamber such that at least some of the elements within the plasma toroid rings undergo collision and nuclear fusion to generate the nuclear fusion particles.

### CROSS-REFERENCE TO RELATED APPLICATIONS

The present U.S. Utility Patent application claims priority pursuant to 35 U.S.C. § 119(e) to U.S. Provisional Application No. 63/679,249, entitled “Advanced Fuel Oscillating Fusion Reactor”, filed Aug. 5, 2024, which is hereby incorporated herein by reference in its entirety and made part of the present U.S. Utility Patent Application for all purposes.

### STATEMENT REGARDING FEDERALLY SPONSORED RESEARCH OR DEVELOPMENT

This invention was made with government support under Award Number (FAIN): 2110396, Project Title: “SBIR Phase II: A Plasma Heat Engine for Efficient Production of Fusion Energy” awarded by NATIONAL SCIENCE FOUNDATION. The government has certain rights in the invention.

### INCORPORATION-BY-REFERENCE OF MATERIAL SUBMITTED ON A COMPACT DISC

Not Applicable.

### BACKGROUND OF THE INVENTION

### Technical Field of the Invention

The disclosed subject matter relates to plasma physics and nuclear fusion and more particularly to nuclear fusion as may be performed within a novel advanced fuel oscillating fusion reactor capable of generating power and/or energy based on nuclear fusion.

### Description of Related Art

Nuclear fusion has been of significant interest for many years. One area of significant interest within nuclear fusion has been power and/or energy generation. While there has been great interest in the research and development of nuclear fusion for such power generation related applications, the prior art does not provide practical and cost-effective solutions by which nuclear fusion may be implemented.

The history and interest of nuclear fusion can be traced back to the beginning of the 20th century and the advent of quantum physics and nuclear physics. Nuclear fusion was in fact achieved in the operation of the hydrogen bomb (H-bomb). However, an effective nuclear fusion reactor must, of course, be controllable and sustainable in order to be a useful power and/or energy source. Although significant effort of the research and development for an effective nuclear fusion reactor has been ongoing for several decades dating back to the early decades of the 20th century, the prior art and conventional approaches have not provided for controllable, sustainable, practical, and cost-effective solutions by which nuclear fusion may be implemented.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

FIGS. 1A, 1B, and 1C are schematic block diagrams of embodiments of nuclear fusion;

FIG. 2A is a schematic block diagram of an embodiment of a nuclear fusion electric power source servicing a home via an electric power grid;

FIG. 2B is a schematic block diagram of an embodiment of a fusion-powered spacecraft;

FIG. 3 is a diagram depicting the relationship between fusion cross section as a function of center of mass kinetic energy showing lower energies effectively eliminate fusion;

FIG. 4 is a diagram depicting particle trajectory within a harmonic oscillator showing that all particles of the plasma have the same period in accordance with rigid rotor rotation;

FIG. 5 is a diagram showing that the axial distribution function of particles within the plasma becomes the velocity distribution every quarter of harmonic oscillation and parameters of a toroid ring (e.g., a circular toroid ring in this diagram);

FIG. 6A is a schematic block diagram of an embodiment of a fusion device that includes electromagnetic field coils configured to facilitate harmonic oscillation of toroid rings of a plasma;

FIG. 6B is a schematic block diagram of an embodiment of a fusion device that also includes an electromagnetic driving coil;

FIG. 7A-7M are schematic block diagrams of various embodiments of a fusion device that is configured to operate with one or more direct energy converters located at each end of the fusion device;

FIG. 8A-8B are schematic block diagrams of embodiments of an electrostatic potential shaping device;

FIG. 9 is a schematic block diagram of an embodiment of a toroid ring of a plasma implemented that is configured to undergo rigid rotor rotation;

FIG. 10 is a schematic block diagram of an embodiment of two toroid rings of a plasma that are configured to oscillate harmonically along the center axis of a fusion device while also undergoing rigid rotor rotation;

FIG. 11A is a schematic block diagram of an embodiment of two toroid rings of a plasma that are configured to oscillate harmonically along the center axis of a fusion device while also undergoing rigid rotor rotation in relation to a fusion device that includes magnetic field coils configured to facilitate harmonic oscillation of toroid rings of a plasma;

FIG. 11B is a diagram of an embodiment of inner and outer coils as can be implemented within a fusion device;

FIG. 12A-12B are schematic block diagrams of an embodiment of harmonic oscillation of two toroid rings of a plasma as a function of time;

FIG. 13A is a schematic block diagram of an embodiment of two toroid rings of a plasma that are configured to oscillate harmonically along the center axis of a fusion device while substantially maintain their shape during the harmonic oscillation;

FIG. 13B is a schematic block diagram of an embodiment of two toroid rings of a plasma that are configured to oscillate harmonically along the center axis of a fusion device while changing their shape during the harmonic oscillation;

FIG. 13C is a schematic block diagram of another embodiment of two toroid rings of a plasma that are configured to oscillate harmonically along the center axis of a fusion device while changing their shape during the harmonic oscillation;

FIG. 13D is a schematic block diagram of another embodiment of two toroid rings of a plasma that are configured to oscillate harmonically along the center axis of a fusion device while changing their shape during the harmonic oscillation;

FIG. 14A is a schematic block diagram of an embodiment of tickling the electric or magnetic field of a fusion device with radio frequency (RF) signals at twice the harmonic oscillator frequency;

FIG. 14B is a schematic block diagram of an embodiment of tickling the electric field of a fusion device with radio frequency (RF) signals of various frequencies;

FIG. 14C is a schematic block diagram of an embodiment of tickling the magnetic field of a fusion device with radio frequency (RF) signals of various frequencies; and

FIG. 15 is a schematic block diagram of an embodiment of a system that includes one or more processing modules configured to facilitate operation of an advanced fuel oscillating fusion reactor.

### DETAILED DESCRIPTION OF THE INVENTION

The disclosure is generally directed to nuclear fusion. The disclosure includes multiple embodiments, examples, features, and/or aspects of a fusion device that is configured to facilitate nuclear fusion and also associated methods of nuclear fusion. Note that such a fusion device may alternatively referred to as an advanced fuel oscillating fusion reactor within the disclosure.

In an example of operation and implementation, the fusion device includes a vacuum chamber within which electromagnetic fields are generated. These may be generated by driving electrical current through one or more electromagnetic coils (alternatively referred to as windings, coils, solenoids, or equivalent in the art that are wrapped around at least some portions of the vacuum chamber) to facilitate formation of and harmonic oscillation of plasma toroid rings therein. For example, such electromagnetic coils may be implemented using any of a variety of conductive materials. In some examples, electromagnetic coils are implemented using copper wiring. In other examples, electromagnetic coils are implemented using aluminum wiring. Generally speaking, any appropriate material that, when implemented within one or more electromagnetic coils, is configured to provide electromagnetic induction within the volume of the vacuum chamber may be used.

By appropriately driving electrical current through these electromagnetic coils, plasma included within the vacuum chamber of the fusion device is formed into two plasma toroid rings. These two plasma toroid rings then undergo harmonic oscillation within the vacuum chamber of the plasma fusion device. For example, these plasma toroid rings undergo harmonic oscillation along the center axis of the fusion device (e.g., within the vacuum chamber of the fusion device), the plasma toroid rings also undergo poloidal rotation. The magnetic field within the vacuum chamber of the fusion device lies poloidally symmetric around a central axis of the vacuum chamber. In some examples, a center electrode is implemented along a central axis of the vacuum chamber. Also, this center electrode includes one or more electromagnetic coils that are also used to effectuate electromagnetic fields within the vacuum chamber.

For example, as the plasma toroid rings traverse back and forth along the center axis of the fusion device, they also rotate. As they traverse axially in accordance with the harmonic oscillation, they also undergo rotation around that center axis. In addition, as these two plasma toroid rings undergo harmonic oscillation along the center axis of the fusion device, while also undergoing rotation, they collide with and pass through one another, and at least some of the particles within each of the two plasma toroid rings collide with one another. These collisions facilitate nuclear fusion.

From certain perspectives, the operation of the fusion device that includes electromagnetic coils has some similarities to a magnetic mirror field (MMF). The two plasma toroid rings collide with one another in accordance with this harmonic oscillation and rotation to effectuate nuclear fusion of atomic nuclei included within the two oscillating plasma toroid rings.

As described in greater detail below, two or more elements are included within the two oscillating plasma toroid rings within the vacuum chamber of the fusion device. In certain examples, Hydrogen and Boron are the two elements that are included within the two oscillating plasma toroid rings within the vacuum chamber of the fusion device. Generally, note that alternative elements suitable to effectuate nuclear fusion may be used in other embodiments.

Generally speaking, the two plasma toroid rings oscillate back and forth along the center axis within the vacuum chamber of the fusion device while also rotating around that center axis as they traverse along the length of the fusion device. They reverse path at the respective ends of the fusion vacuum chamber of the fusion device and traverse in the opposite direction. Also, in certain implementations, the two plasma toroid rings rotate around the center axis within the vacuum chamber of the fusion device at approximately the same rate and also traverse the length of the fusion device at approximately the same rate.

In certain examples, the two plasma toroid rings are similar in size, shape, form, content, and undergo a similar motion and round-trip path/orbit within the fusion device. Also, the two plasma toroid rings rotate in accordance with rigid rotor rotation such that there is little or no shear flow of the atomic nuclei within the two plasma toroid rings. As described herein, by reducing any shear flow or eliminating shear flow of the atomic nuclei within the two plasma toroid rings, this keeps the temperature of the plasma within the fusion device cool or cold, and there is also a decoupling of the two plasma toroid rings from the inner wall of the vacuum chamber of the fusion device. For example, by keeping radiation losses small, a very low electron temperature for the plasma may be achieved (e.g., electron temperature, Tₑ, of a few electron volts (eV) or less than 10 s of eV or a few hundreds of eV). Also, keeping the plasma temperature at such low values significantly reduces or fully eliminates thermal fusion within the advanced fuel oscillating fusion reactor (fusion device).

The novel approaches of performing nuclear fusion as described herein provide for operation of a fusion device and associated methods of performing nuclear fusion that may be used for a variety of purposes including providing power, energy, electric current, thrust (such as for a spacecraft), etc. For example, the resultant of such nuclear fusion may include providing power and/or energy to remote locations where it may be difficult if not impossible for delivery of power and/or energy using conventional means. Examples of other applications may include energy storage, providing electric current to operate various components such as electric motors, providing direct energy output for ion thruster applications such as within spacecraft, and/or other purposes. Generally speaking, any of a wide variety of applications, devices, components, etc. may benefit from directly and/or indirectly by using the particles, power, and/or energy output from such a fusion device.

Also, the manner by which nuclear fusion is performed herein includes no neutrons in the fusion chain, and thereby eliminates any typically radiation-related problems associated with prior art attempts to implement nuclear fusion. The nuclear fusion as performed herein is a much safer approach of nuclear fusion than prior art approaches to nuclear fusion making it an excellent candidate for applications that would suffer adversely with exposure to unacceptable levels of radiation (e.g., radiation exposure to astronauts in manned spacecraft travel applications). The reduction or mitigation of radiation provides a huge benefit for long-haul or long-duration manned spacecraft travel including significant safety improvement for astronauts in comparison to prior art nuclear fusion approaches (e.g., that include neutrons in the fusion chain).

Such nuclear fusion as described herein within a plasma environment may be performed at temperatures that are much lower than those found within prior art, typical plasma environments. Such temperatures may generally be referred to as cold plasma environments in comparison to prior art, typical plasma environments. By operating at relatively much cooler temperatures, the plasma within the device can thermally decouple from the interior walls of the fusion device, so there is no warming of the vacuum chamber of the fusion device by virtue of the plasma being decoupled to the interior walls of the fusion device. The nuclear fusion is achieved based on the motion of the plasma toroid rings colliding with one another in accordance with the harmonic oscillation of the plasma toroid rings within the fusion device, and not in accordance with thermal heating/thermal energy in the plasma within the fusion device.

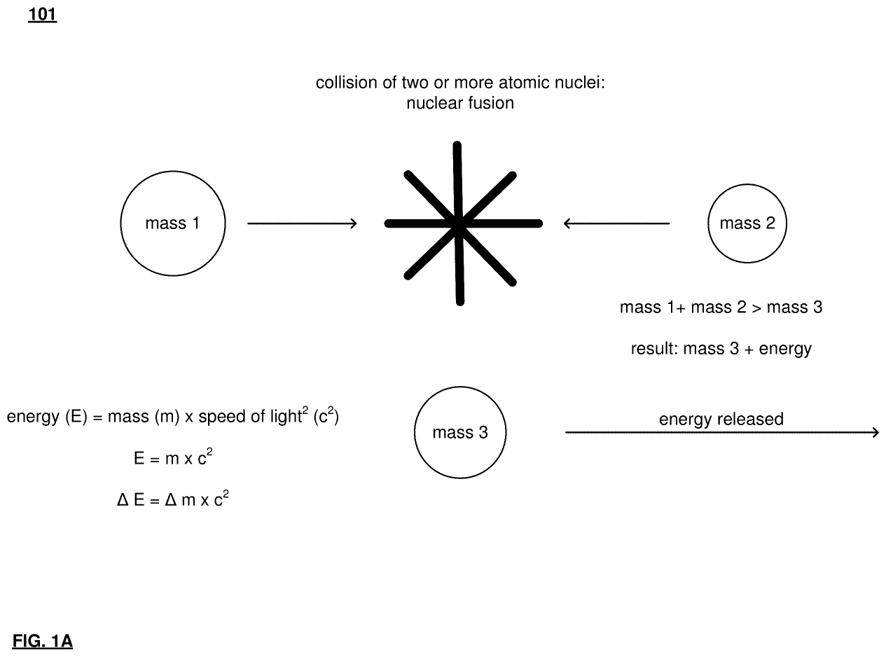

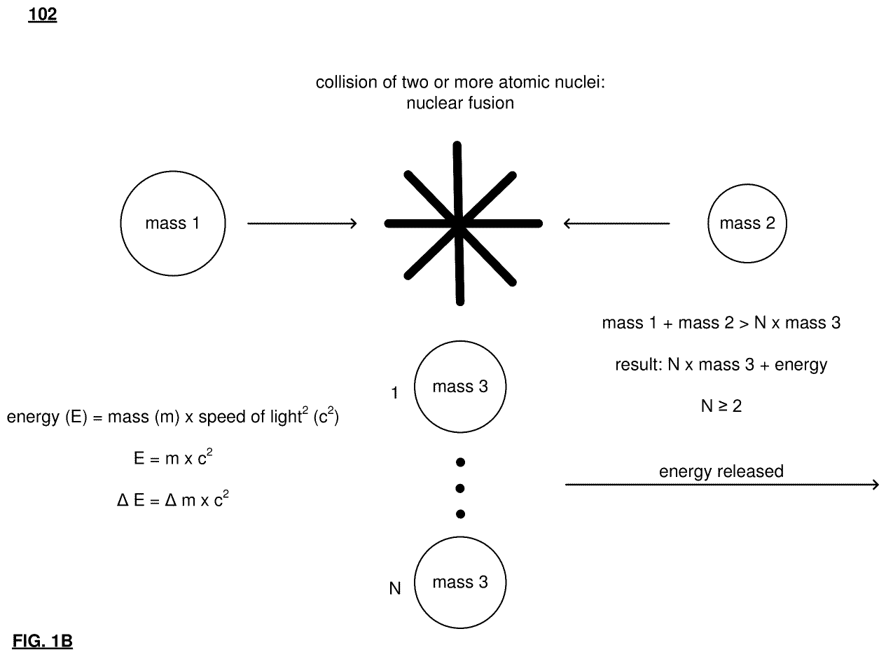

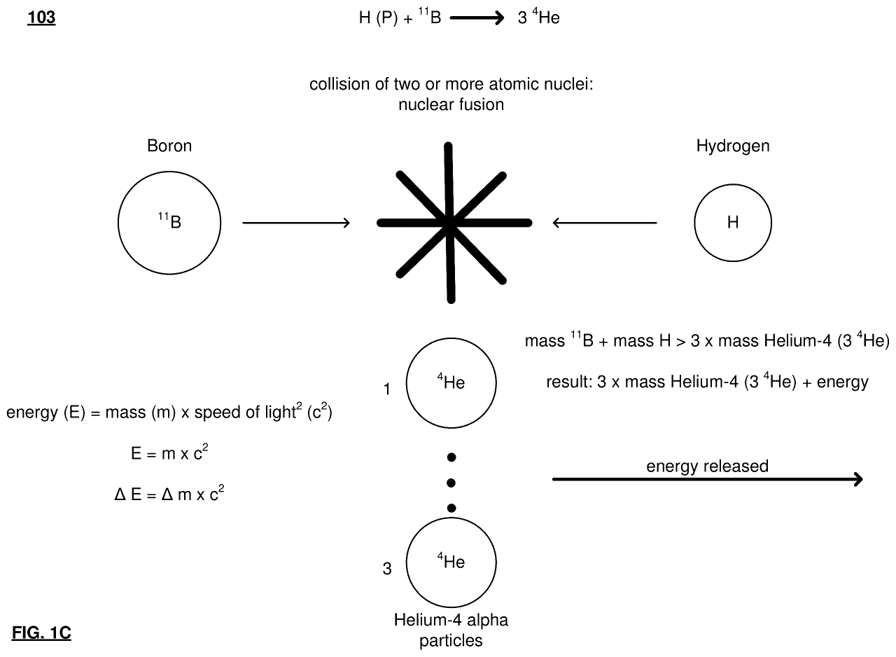

FIGS. 1A, 1B, and 1C are schematic block diagrams of embodiments of nuclear fusion. Referring to embodiment 101 of FIG. 1A, generally speaking, nuclear fusion is the process by which two or more original (reactant) atomic nuclei collide with one another and combine to form one or more resultant (product) atomic nuclei and/or subatomic particles. The difference in mass between the original (reactant) two or more different atomic nuclei and/or subatomic particles and the one or more resultant (product) after nuclear fusion corresponds to whether there is a release or absorption of energy in accordance with the nuclear fusion process. A nuclear fusion process in which the one or more resultant (product) atomic nuclei and/or subatomic particles after nuclear fusion is less than the combined mass of the two or more original (reactant) atomic nuclei and/or subatomic particles will result in a release of energy. In general, the change of mass (the leftover mass) becomes energy in such nuclear fusion.

In contrast, a nuclear fusion process in which the one or more resultant (product) atomic nuclei and/or subatomic particles after nuclear fusion is more than the combined mass of the two or more original (reactant) atomic nuclei will result in an endothermic reaction and absorption of energy. Certain embodiments described herein relating to nuclear fusion are directed towards those reactions that result in the release of energy.

Considering the very simple example shown in this diagram, consider that two different atomic nuclei having different respective masses, mass 1 and mass 2, undergo a collision and combination with one another to produce different atomic nuclei having a different respective mass, mass 3. In this example, the combined mass 1 and mass 2 is more than the resulting mass 3, and thereby the nuclear fusion process results in the release of energy.

Considering the mass-energy equivalence principle described by Albert Einstein in his formula, E=m×c², where E is energy, m is mass, and c is the speed of light, it can be seen that a change of energy, ΔE, may also be attributed to a change of mass, Δm, with respect to this relationship, such that ΔE=Δm×c².

As can be seen, based on the change of mass such as may be effectuated during collision of two or more atomic nuclei with one another, there may be a corresponding change of energy. In this simple example of this diagram, the change of mass, Δm, resulting from the nuclear fusion will result in either the release of energy or the absorption of energy.

Referring to embodiment 102 of FIG. 1B, this diagram is similar to the previous diagram with at least one difference being that multiple respective resultant (product) atomic nuclei and/or subatomic particles are produced as a result of the nuclear fusion process. For example, consider that a number, N, of the mass 3 resultant (product) atomic nuclei and/or subatomic particles are produced as a result of the nuclear fusion process, where Nis a positive integer greater than or equal to 2. A similar analysis may be made such that when the mass of the N resultant (product) atomic nuclei and/or subatomic particles after nuclear fusion (e.g., N×mass 3) is less than the combined mass of the two or more original (reactant) atomic nuclei and/or subatomic particles (e.g., combined mass 1 and mass 2), there is a release of energy. Again, the change of mass (the leftover mass) becomes energy in such nuclear fusion.

With respect to embodiment 101 of FIG. 1A and embodiment 102 of FIG. 1B, note that various elements may generally be used to effectuate nuclear fusion. Certain elements are more suitable for certain applications. The following diagram is directed towards the use of Hydrogen and Boron.

Referring to embodiment 103 of FIG. 1C, this diagram shows a specific implementation by which the original (reactant) atomic nuclei and/or subatomic particles Include both Hydrogen (alternatively shown as P for proton) and Boron. For example, the Boron used in such a nuclear fusion process is Boron-11 isotope, ¹¹B, with an atomic weight 11, which has a corresponding relative atomic mass of approximately 11.009306. In this diagram, Hydrogen and Boron collide with one another and generate three (3) Helium-4 (⁴He) particles with the release of energy. Note that Helium-4 (⁴He) particles are sometimes alternatively referred to as alpha particles.

$$H + {}^{11} B \to 3 {}^{4} He$$

For example, a fusion device includes a plasma of Hydrogen and Boron. By driving the electromagnetic coils of the fusion device, operation having some similarities to that of a magnetic mirror field (MMF) is generated, and two (2) respective toroid rings are formed. By appropriately driving the electromagnetic coils of the fusion device, the two respective plasma toroid rings are set into harmonic oscillation along the center axis of the fusion device while also undergoing rotation around that center axis during the harmonic oscillation along the center axis of the fusion device. Certain of the Hydrogen and Boron included within the two respective toroid rings collide with one another and undergo nuclear fusion thereby forming Helium-4 (⁴He) particles and also releasing energy.

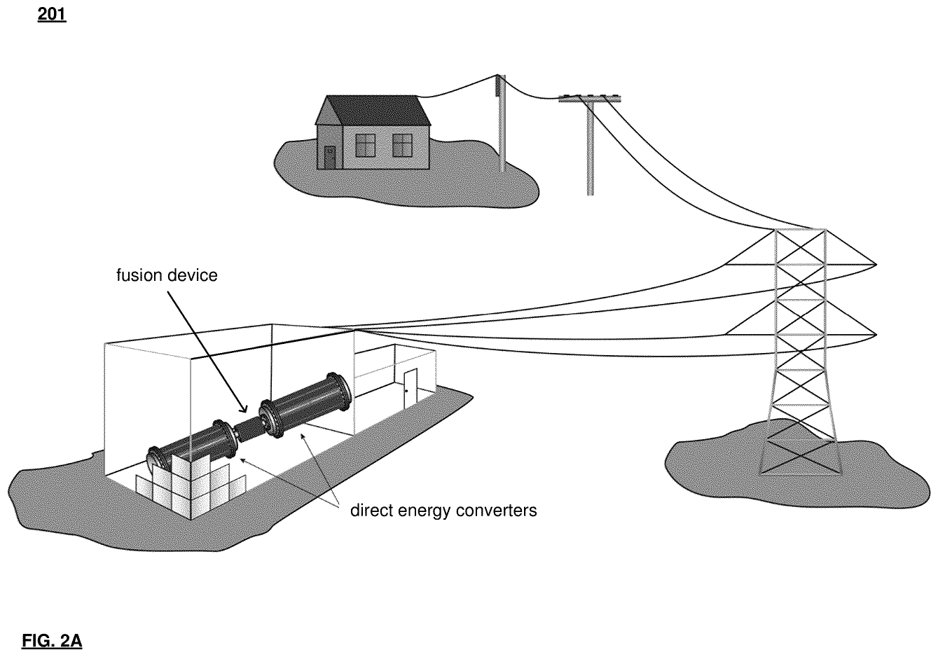

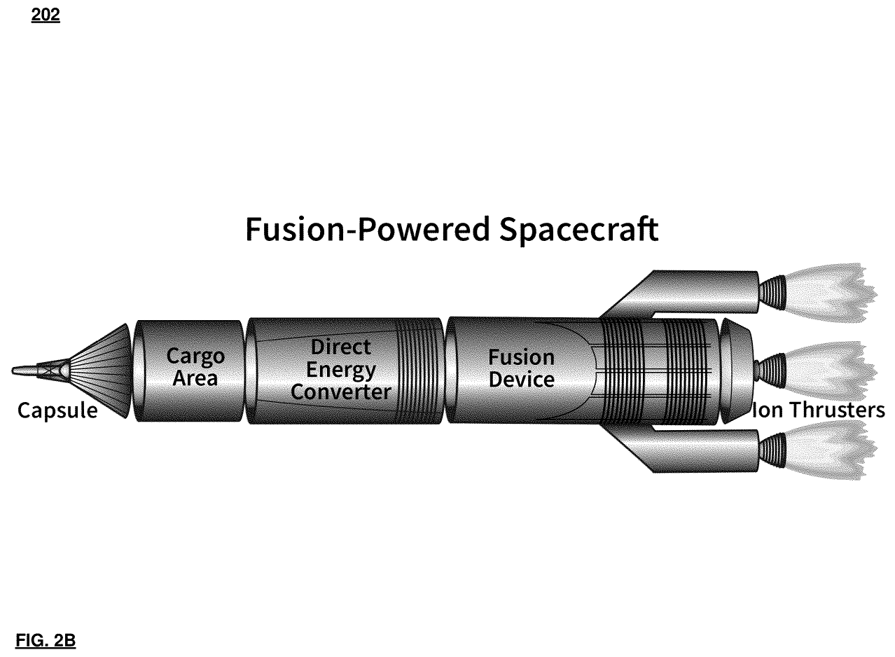

FIG. 2A is a schematic block diagram of an embodiment 201 of a nuclear fusion electric power source servicing a home via an electric power grid. This diagram generally shows a fusion device coupled to direct energy converters at each end. The direct energy converters convert the stream of particles output from the ends of the fusion device into a desired, appropriate format. For example, the direct energy converters convert the stream of particles output from the ends of the fusion device into an electric power signal (e.g., an electric power signal having a desired voltage and capable of delivering a desired current). This electric power signal is provided to an electric power grid. Within the electric power grid, electric power is provided via distribution or transmission lines to one or more loads (e.g., a home, a business, an industrial plant, etc. or alternatively a specific component such as a motor, a charging station such as for electric vehicles, etc.; generally, any load that is operative to use and consume electric power).

This diagram shows an example of how such an advanced fuel oscillating fusion reactor (fusion device) as described herein may be implemented in a variety of locations including remote locations and operate as an effective source of power and/or energy. In this particular example, one or more advanced fuel oscillating fusion reactors (fusion devices) is implemented to provide electric power to an electric power grid.

However, in other examples, note that one or more advanced fuel oscillating fusion reactors (fusion devices) is implemented to provide electric power directly to a load without being attached to an electric power grid. For example, consider an implementation in which a load is remotely located away from any electric power grid by which electric power service may be provided to it. In such an example, an advanced fuel oscillating fusion reactor (fusion device) is provisioned locally nearby that remotely located load to provide electric power to it without necessarily being coupled to an electric power grid. The benefits and utility of such implementations are many. For example, in certain situations, it is cost prohibitive to connect very remotely located loads to an electric power grid to receive electric power from the electric power grid. Such an advanced fuel oscillating fusion reactor (fusion device) having a relatively small footprint (e.g., less than 3 ft×3 ft×6 ft in some implementations, less than 6 ft×6 ft×20 ft in other implementations) and able to be provisioned nearby such a remotely located load provides the opportunity for the use of power and/or energy consuming loads virtually anywhere on Earth or on other terrestrial bodies.

Such an advanced fuel oscillating fusion reactor (fusion device) could be implemented in very remote locations on Earth including the Arctic or the Antarctic, the Sahara Desert, the Amazon Jungle and River Basin, and/or any other location on Earth to service one or more power and/or energy consuming loads. Examples of such terrestrial related loads include motors, water pumps, fans, air conditioning systems, lighting systems, computer systems, communication systems, etc. as may be used within various terrestrial environments.

Such an advanced fuel oscillating fusion reactor (fusion device) could also be implemented on the moon, mars, or some other terrestrial body to service one or more power and/or energy consuming loads. Examples of such space exploration related loads include water recovery systems, oxygen generators, pressurized oxygen tanks, solid fuel oxygen generators, life support systems, computer systems, communication systems, etc. as may be used within the space exploration.

FIG. 2B is a schematic block diagram of an embodiment 202 of a fusion-powered spacecraft. This diagram generally shows a fusion-powered spacecraft that includes a fusion device. At one end of the fusion device is a direct energy converter that is configured to generate power for consumption by one or more of the cargo areas and a capsule of the spacecraft. At the other end of the fusion device are one or more ion thrusters that operate to propel the spacecraft. For example, the ion thrusters are configured to generate thrust based on the output from that end of the fusion device. In certain examples, the ion thrusters operate using the stream of particles directly output from the fusion device as the thrust mechanism. In other examples, the ion thrusters operate by converting the stream of particles output from the fusion device into another format that is different from that which is directly output from the fusion device.

Examples of such space exploration related loads within the cargo area and/or capsule of the fusion-powered spacecraft include water recovery systems, oxygen generators, pressurized oxygen tanks, solid fuel oxygen generators, life support systems, control systems, computer systems, communication systems, etc. as may be used within the space exploration.

Such an advanced fuel oscillating fusion reactor (fusion device) as described herein can be implemented with a relatively small footprint making it available for a wide variety of applications including terrestrial applications, space applications, etc.

Generally speaking, nuclear fusion may be viewed as a process that can produce energy by fusing light elements. Using prior art approaches, achieving sustained fusion reactions has proven to be quite difficult because of the required high energies of the fusing nuclei and energy losses from the plasma.

Among other improvements over the prior art and conventional approaches, this disclosure includes a significant enhancement on the confinement of the plasma to be used to effectuate nuclear fusion. For example, this is achieved by making the energy confinement time (τ_{E}) large. τ_{E} is a measure of the time that energy is contained in the plasma, and it is a global characterization of how well the plasma keeps its energy from leaking out (e.g., how well the plasma remains confined). It is usually associated with the Lawson criteria as described in <Reference 1> (nτ_{E}, where n is the plasma density), which describes the energy balance in a plasma.

Plasma confinement is provided by the EXB drift motion. The equation of motion is as follows:

$${m}_{α} d {v}_{α} / dt = {q}_{α} ( E + {v}_{α} x B )$$

where m_{α} is the particle mass, v_{α} is the particle velocity, q_{α} is the particle charge, E is the electric field and B is the magnetic field. Note that a designates the species, either ions or electrons.

Crossing this equation above with the magnetic field, B, and ordering the inertia small yields the drift velocity, V_{Drift}, approximation:

$${V}_{drift} = ExB / B \cdot B$$

In certain examples, note that the drift velocity, V_{Drift}, is the same for both ions and electrons, since it is independent of both charge and mass. Consequently, ions and electrons drift together, and these drifts do not result in charge separation. This makes the plasma quasi-neutral.

An advanced fuel oscillating fusion reactor (fusion device) as described herein can be implemented with significantly less cost than conventional and prior art approaches to effectuate nuclear fusion. It also provides for a much smaller size and footprint of a fusion device in comparison to conventional and prior art approaches to effectuate nuclear fusion.

FIG. 3 is a diagram depicting the relationship 300 between fusion cross section as a function of center of mass kinetic energy showing lower energies effectively eliminate fusion.

Keeping the plasma temperatures down to a few electron volts (eV) also effectively eliminates thermal fusion (as shown in FIG. 3). In an advanced fuel oscillating fusion reactor (fusion device) as described herein, fusion is produced by the axial collision of toroid rings of the plasma in an effective harmonic oscillator potential.

This operation has certain similarities to the operation described in <Reference 2>. Note that an advanced fuel oscillating fusion reactor (fusion device) as described herein also includes many differences and distinctions from the system disclosed in <Reference 2>.

In this system, the relative velocities of the toroid rings of plasma are high enough to produce fusion when they collide with each other.

In certain instances, fuel fusion reactors can require ring energies that are significantly higher than for deuterium-tritium (D-T) fusion reactions. This can be seen in FIG. 3 where the reactivity cross-sections for D-T peak at about 60 keV while the reactivity cross-sections for proton-Boron11 (p-¹¹B) peak at about 600 keV, as described in <Reference 3>. FIG. 3 is from <Reference 3> and shows the fusion cross sections of Deuterium-Tritium (DT), Deuterium-Deuterium (DD) and proton-Boron (p-¹¹B) as a function of the center of mass kinetic energy. The dotted line indicates the energy of the higher cross section resonance (~600 keV).

Keeping the plasma temperatures low allows the rings to achieve these higher energies without increasing the plasma radiation losses (e.g., Bremsstrahlung losses) or the cross-field diffusion losses.

Using advanced fuels like Hydrogen and Boron (e.g., H-¹¹B or P-¹¹B) has significant advantages over the D-T fuel cycle. As described above, the fusion reaction is as follows:

H+1¹B→3 ⁴He, or alternatively denoted as

$$P + {}^{11} B \to 3 {}^{4} He$$

One of the many advantages provided by the novel and improved manner by which nuclear fusion is performed within an advanced fuel oscillating fusion reactor (fusion device) as described herein is that this fusion reaction produces no neutrons and yields three Helium nuclei (3 ⁴He). This eliminates any serious neutron damage to the wall materials of the advanced fuel oscillating fusion reactor (fusion device) that are created by both the D-T and the D-D fusion reactions. It also does not create radioactive by-products. These breakthrough improvements over prior art, conventional fusion reactors are significant. This disclosure provides a much safer environment for personnel who may be in the vicinity of an advanced fuel oscillating fusion reactor (fusion device). For example, consider an application in which an advanced fuel oscillating fusion reactor (fusion device) as described herein is implemented as a power and/or energy source in a spacecraft. The astronauts within such a spacecraft would not be subject to damaging radiation (e.g., Bremsstrahlung radiation) thereby enabling long haul and long duration space travel missions by astronauts.

Another advantage of such an advanced fuel oscillating fusion reactor (fusion device) as described herein is that all of the energy is included in charged particles (⁴He). These particles can be direct energy converted (e.g., using direct energy converters) into electricity with an efficiency that is in excess of 90%. In contrast, prior art, conventional fusion reaction systems require that neutrons to be converted into electricity using a thermal cycle with likely efficiencies in a range around approximately ~40%.

Among the many improvements and technical advantages provided by such an advanced fuel oscillating fusion reactor (fusion device) as described herein are innovations and mechanisms to minimize plasma heating and also to improve plasma confinement within the advanced fuel oscillating fusion reactor (fusion device). From certain perspectives, the significant improvements provided by the advanced fuel oscillating fusion reactor (fusion device) as described herein directly facilitate the reduction in plasma heating. For example, by ensuring that the plasma is well confined within the advanced fuel oscillating fusion reactor (fusion device), the plasma is thermally decoupled from the walls of the fusion advanced fuel oscillating fusion reactor (fusion device). Again, one of many benefits of performing nuclear fusion using devices and/or methods as described herein, the nuclear fusion is effectuated from the motion of the plasma toroid rings, and not from heat within the advanced fuel oscillating fusion reactor (fusion device).

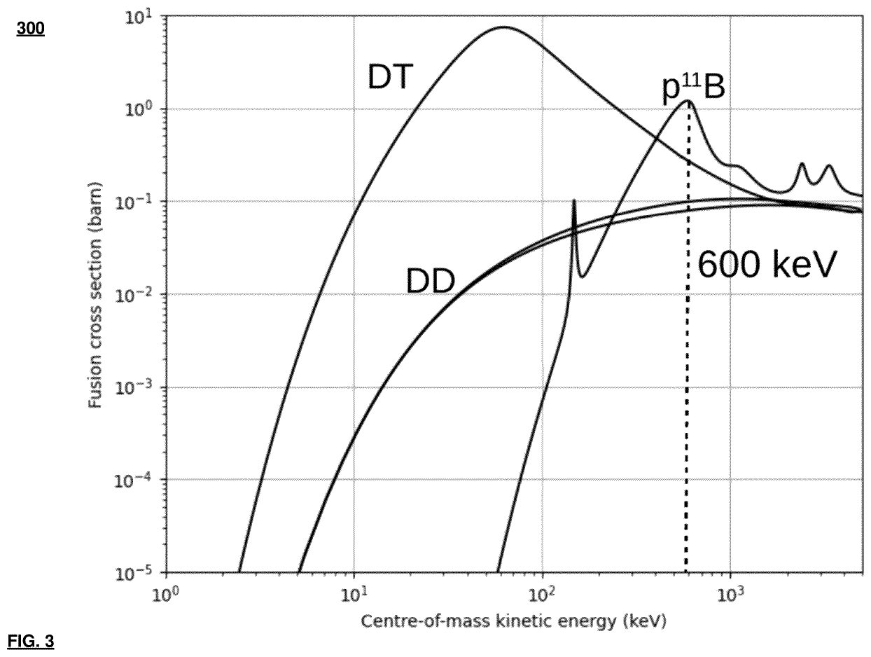

FIG. 4 is a diagram depicting particle trajectory 400 within a harmonic oscillator showing that all particles of the plasma have the same period in accordance with rigid rotor rotation. For example, as a plasma toroid ring rotates around the center axis of the fusion device.

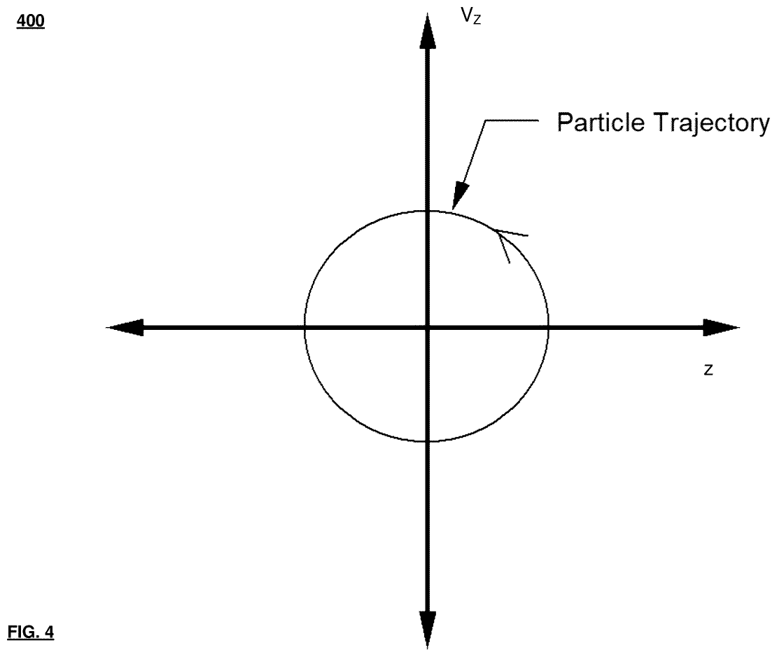

FIG. 5 is a diagram showing that the axial distribution function of particles within the plasma becomes the velocity distribution every quarter of harmonic oscillation 501 and 502 and parameters of a toroid ring 503 (e.g., a circular toroid ring in this diagram).

The axial distribution function is shown on the left-hand side (LHS), reference numeral 601, at time, t=0. The axial distribution function is shown on the right-hand side (RHS), reference numeral 602, at time, t=T/4 (one quarter period of harmonic oscillation).

The advanced fuel oscillating fusion reactor (fusion device) operates by generating two plasma toroid rings that are located in an effective axial harmonic oscillator potential. For example, axial harmonic oscillation is described in <Reference 2>. All particles in a harmonic oscillator have the same period as shown in FIG. 4, reference numeral 400. Consequently, the axial particle distribution function moves like a rigid rotor in time as described in <Reference 4> and as shown in FIG. 5, reference numerals 501 and 502. Every quarter period (T/4, where T is the period), the axial distribution becomes the velocity distribution. Collisions drive the distribution towards a thermal (e.g., Maxwellian) distribution. The temperature in the rotating coordinate is then determined by the Full Width at Half Maximum (FWHM) of the Maxwellian distribution function. Since the spatial distribution function interchanges every quarter period with the velocity distribution, it becomes a Gaussian distribution. Consequently, as the temperature becomes small, the axial width of the toroid rings of plasma contract as well. Since the axial motion is harmonic, the radial motion is also harmonic and has the same Gaussian profile.

Earlier work (e.g., as described in <References 3, 4, and 16>) has shown that placing particles in a harmonic oscillator potential allows them to rapidly evolve into a state that never leaves thermodynamic equilibrium.

In addition, placing particles in a harmonic oscillator potential allows them to rapidly evolve into a state that never leaves thermodynamic equilibrium. In a harmonic oscillator potential, all particles have the same frequency of oscillation. FIG. 4 is a phase space trajectory of a particle in a harmonic oscillator potential. Note that the particle trajectory is periodic, and the particle returns to the same position and velocity after a single orbit as shown in FIG. 4.

The collective result of this is that distribution functions of particles in a harmonic oscillator potential move as a rigid rotor (e.g., as described in <Reference 4>). This is shown in FIG. 4. Again, note that every quarter period the particle spatial distribution (reference numeral 501) and the velocity distribution (reference numeral 502) interchange. What used to be the spatial distribution now becomes the velocity distribution. This is shown in FIG. 5, reference numerals 501 and 502. Each dot in FIG. 5 (see reference numerals 501 and 502), represents a particle in phase space. Consequently, every quarter period the previous velocity distribution becomes the spatial distribution, and the previous spatial distribution becomes the velocity distribution.

Collisions cause the velocity distribution to relax into a Maxwellian (Gaussian) distribution. This in turn causes the spatial distribution to become Gaussian. Once these distributions are achieved, the distributions never leave them independent of the plasma collisionality. Collisions only scatter particles into another part of the distribution.

In certain examples, the shape of the toroid rings of plasma is that of a circular toroid ring 503, such that r is the radius of the circular section of the circular toroid ring, and R is the radius of the overall shape of the circular toroid ring. The volume, V, and surface area, S, of such circular toroid ring are as follows:

$$V = 2 {π}^{2} {r}^{2} R$$

$$S = 4 {π}^{2} rR$$

As the temperature of the plasma becomes smaller, the shape of the plasma toroid rings of plasma becomes more similar to a bicycle tire shape rather than an automobile tire or doughnut shape. For example, the shape of the toroid rings of plasma changes such that the radius of the circular section of the circular toroid ring, r, decreases, and the radius of the overall shape of the circular toroid ring, R, increases. The opposite may occur in other examples, such that the shape of the toroid rings of plasma changes such that the radius of the circular section of the circular toroid ring, r, increases, and the radius of the overall shape of the circular toroid ring, R, decreases. In other examples, the shape of the toroid rings of plasma changes such that the radius of the circular section of the circular toroid ring, r, decreases or increases, and the radius of the overall shape of the circular toroid ring, R, remains unchanged. In even other examples, the shape of the toroid rings of plasma changes such that the radius of the circular section of the circular toroid ring, r, remains unchanged, and the radius of the overall shape of the circular toroid ring, R, decreases or increases. In yet other examples, the shape of the toroid rings of plasma changes such that the radius of the circular section of the circular toroid ring, r, changes (e.g., increases or decreases), and the radius of the overall shape of the circular toroid ring, R, also changes (e.g., increases or decreases). Both r and R may increase, both may decrease, or one may increase or decrease while the other remains unchanged.

This means that there will be multiple e-foldings in the Gaussian density profile which will effectively decouple the plasma from the interior wall of the fusion device. As such, the plasma operates as a free-space plasma, and the wall of the fusion device is not a site of thermal conduction.

As shown in FIG. 5, the density profile and the plasma temperature are intimately related. As the plasma gets colder, the density profile will move from something like an automobile tire or doughnut shape to a bicycle tire shape. In this case:

$${P}_{fusion} ∼ {( {r}_{ring} / {r}_{wall} )}^{2}$$

Where, P_{fusion} is the power production that is proportional to the square of ratio of the radius of the plasma toroid ring, r_{ring}, from the center of the center axis of the fusion device and the radius of the inner wall of the fusion device, r_{wall}, from the center of the center axis of the fusion device. This allows for large power production in a small volume. Again, this also leads to several e-foldings in the Gaussian density profile, resulting in tiny plasma densities near the wall. This effectively decouples the plasma from the wall, further restricting thermal transport. The machine effectively operates by facilitating the harmonic oscillation of the plasma within the fusion device as if in free space (e.g., the plasma effectively undergoes harmonic oscillation in free space).

The fusion device is configured to keep ohmic heating small thereby also keeping the thermal energy small. The Spitzer resistivity (or plasma resistivity), η, is an expression describing the electrical resistance in the plasma and was first formulated by Lyman Spitzer in 1950. The Spitzer resistivity (or plasma resistivity), η, decreases in proportion to the electron temperature: η ~Tₑ^{-3/2}. Since the electron temperature, Tₑ, is small, the Spitzer resistivity (or plasma resistivity), η, is large based on this proportional relationship, η~Te^{-3/2} (e.g., as also described in <Reference 5>). Note that the inverse of the Spitzer resistivity (or plasma resistivity), η, is the Spitzer conductivity, σ, where σ=1/η.

Various other parameters scale with the Spitzer conductivity, σ, or the inverse of the Spitzer resistivity (or plasma resistivity), η. For example, the current density, J, scales like 1/η, and the ohmic heating scales like 1/η as well. These will get vanishingly small as Tₑ gets tiny. Thus, keeping the plasma cold keeps the ohmic heating small. Also, viscous heating can be caused by poloidal shear flow in the toroid rings. This is eliminated or significantly mitigated by having the toroid rings poloidal rotation operate in accordance with rigid rotor rotation. Since the low temperatures keep the plasma isolated from the electrodes by keeping the density tiny there, the electrode flow boundary condition does not have a significant effect on the plasma rotation. Also, this includes keeping the plasma from the interior wall of the vacuum chamber of the advanced fuel oscillating fusion reactor (fusion device).

Also, keeping ohmic heating small helps keep the ion and electron temperatures small even if the plasma is well confined. This is achieved by keeping the perpendicular resistivity large. Since the perpendicular resistivity also scales as Te^{-3/2}, keeping the electron temperature small also keeps the ohmic heating small as well. From certain perspectives, this ohmic heating may be viewed as being kept small because there is no current parallel to the magnetic field.

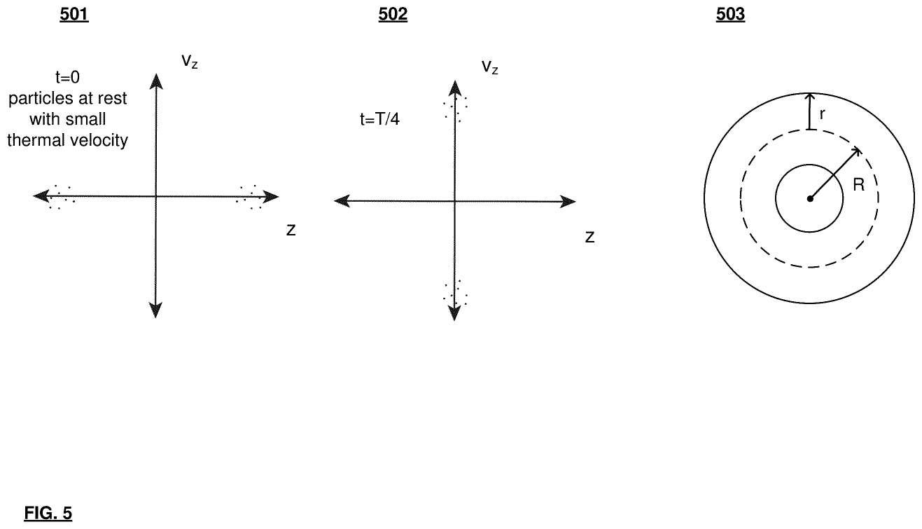

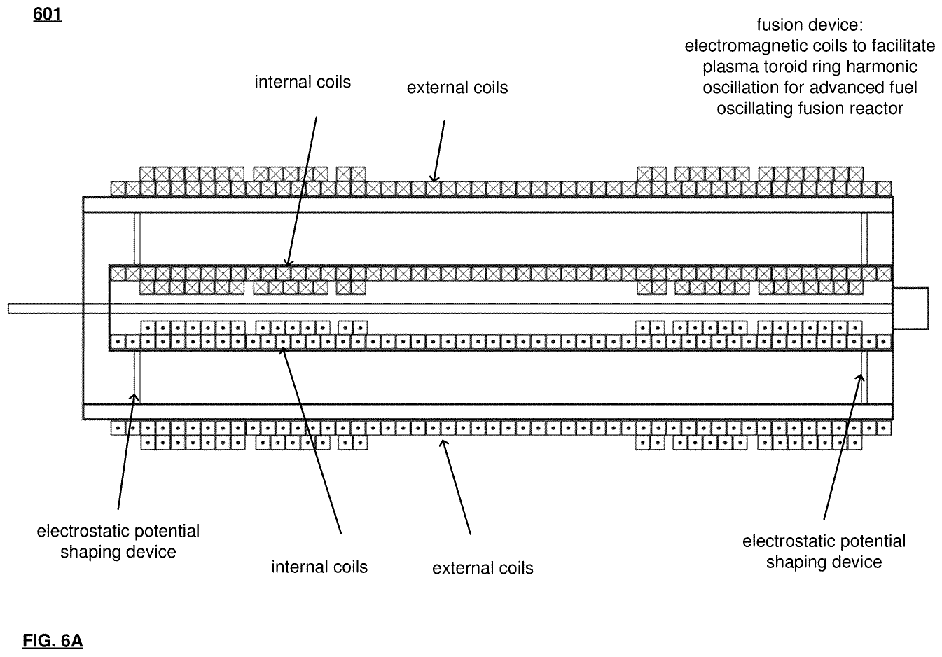

FIG. 6A is a schematic block diagram of an embodiment 601 of a fusion device that includes electromagnetic field coils configured to facilitate harmonic oscillation of toroid rings of a plasma. The electromagnetic field coils for the advanced fuel oscillating fusion reactor (fusion device) are shown in the diagram. There are electromagnetic shaping coils both outside of the vacuum chamber that contain the plasma and inside the inner coils that are inside of the inner electrode that extends along the center axis of the fusion device. These electromagnetic shaping coils are configured both to produce the axial effective harmonic oscillator potential well and to make the toroid rings of plasma spin in accordance with a rigid rotor rotation. This provides for significant improvement in the field of plasma physics by both confining the plasma within a desired space and also by minimizing viscous heating, in contrast to the system as described in <reference 2>.

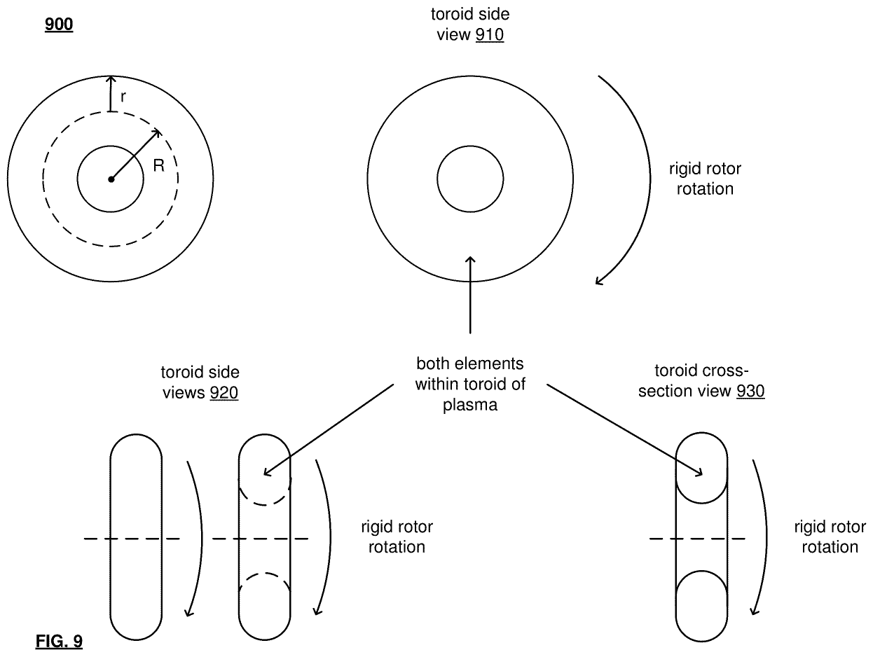

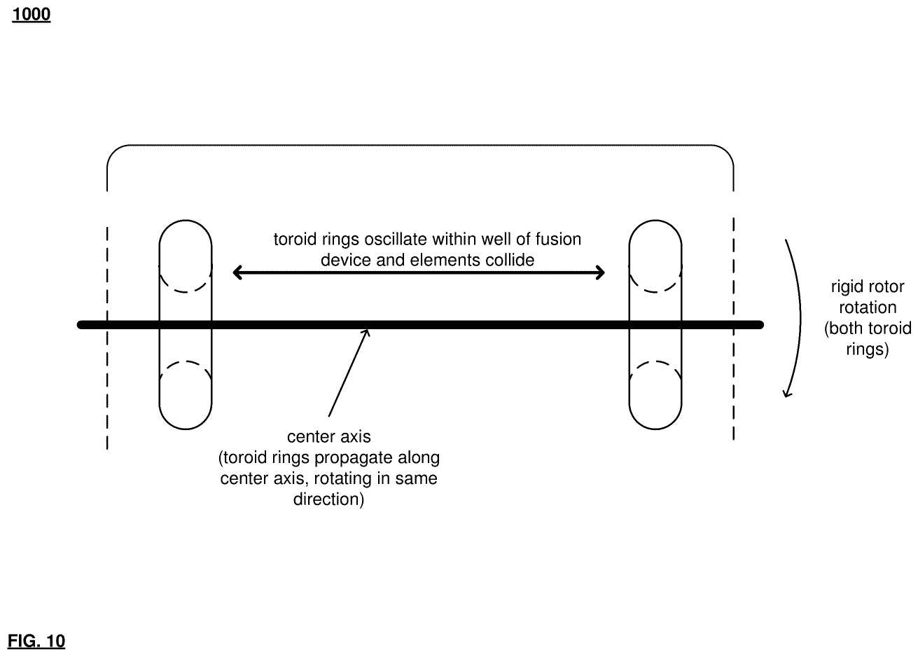

In addition, electrostatic potential shaping devices are implemented near the two respective ends of the vacuum chamber of the advanced fuel oscillating fusion reactor (fusion device). These electrostatic potential shaping devices are implemented axially outside of the harmonic oscillator potential well, so the oscillating plasma does not interact with them directly. Some embodiments of an electrostatic potential shaping device are described with reference to FIGS. 8A and 8B. Note that such an electrostatic potential shaping device may be implemented to include an electron source configured to ionize the plasma.

FIG. 6B is a schematic block diagram of an embodiment 602 of a fusion device that also includes an electromagnetic driving coil. A small driving electromagnetic coil is shown in the diagram. This small driving electromagnetic coil is located on the outer electrode near the center of the harmonic oscillator well. Oscillating this electromagnetic coil with a signal (e.g., a radio frequency (RF) signal, such as a signal having a frequency within the RF frequency range, a radio wave, etc.) at twice the axial resonant frequency not only adds axial energy to the rings, but it also separates the plasma into the two plasma toroid rings to facilitate nuclear fusion of the elements included therein.

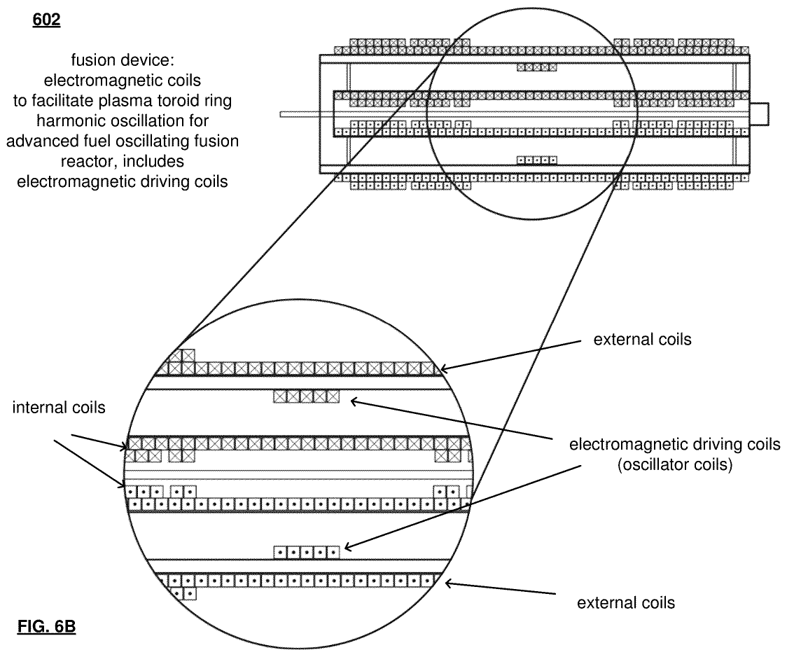

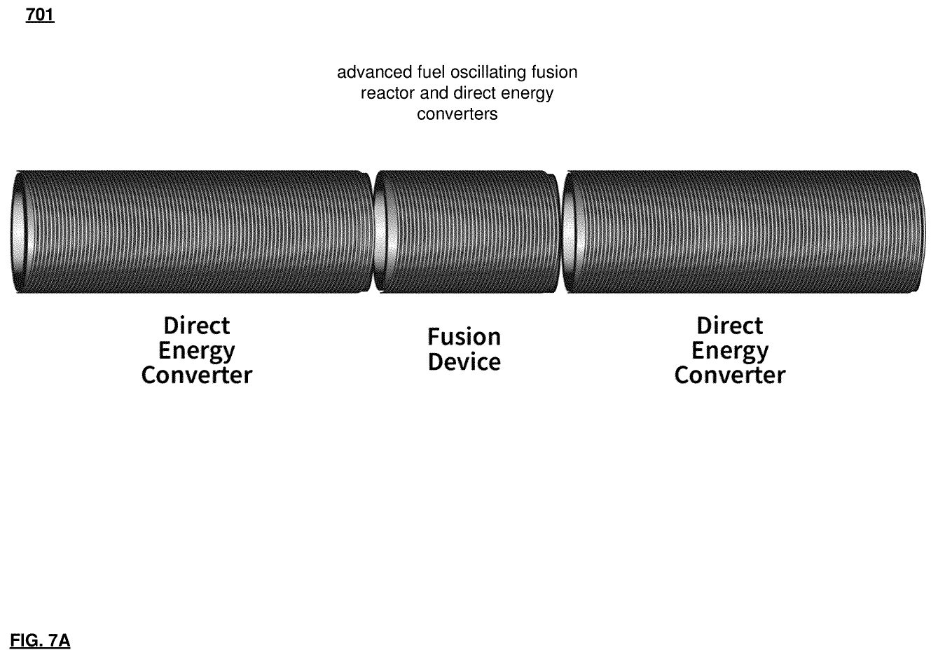

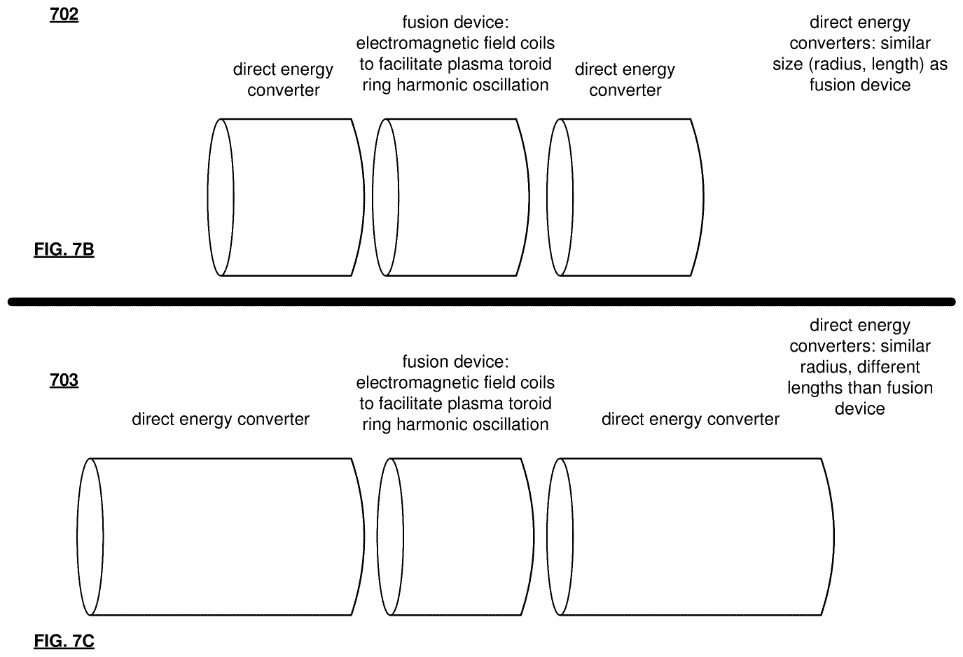

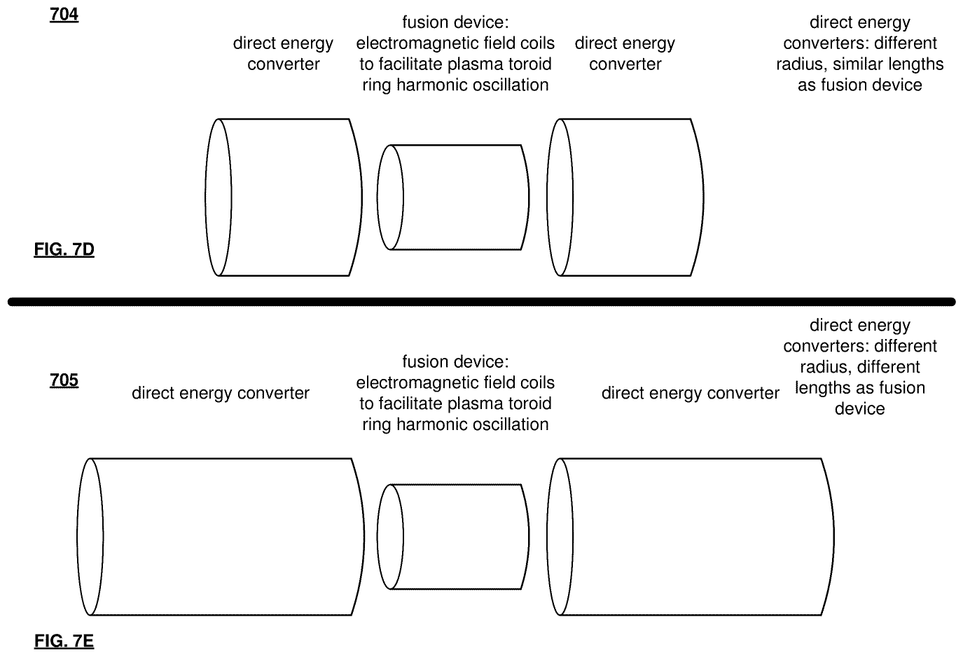

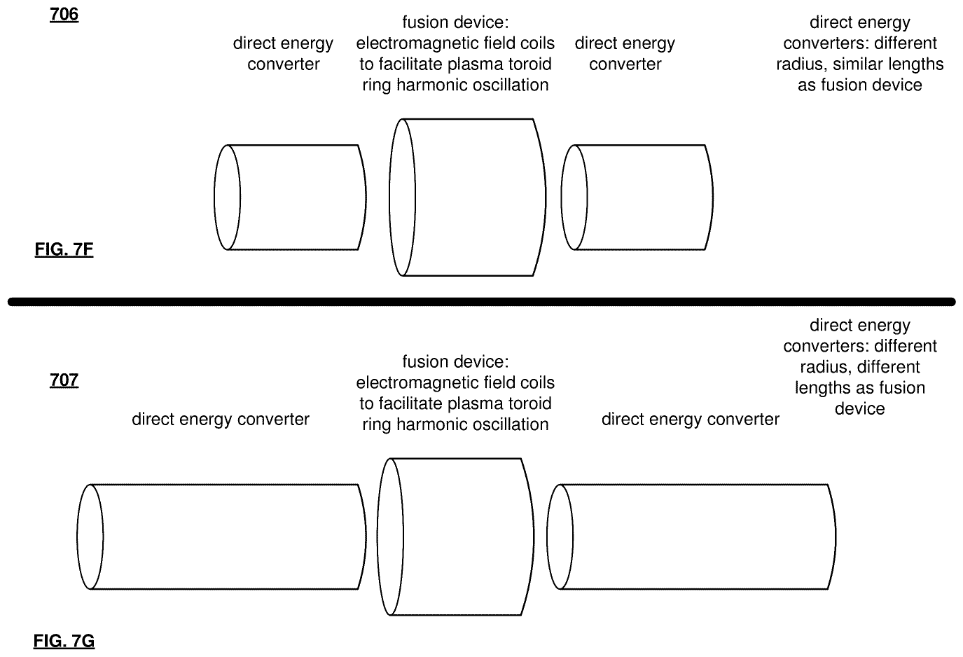

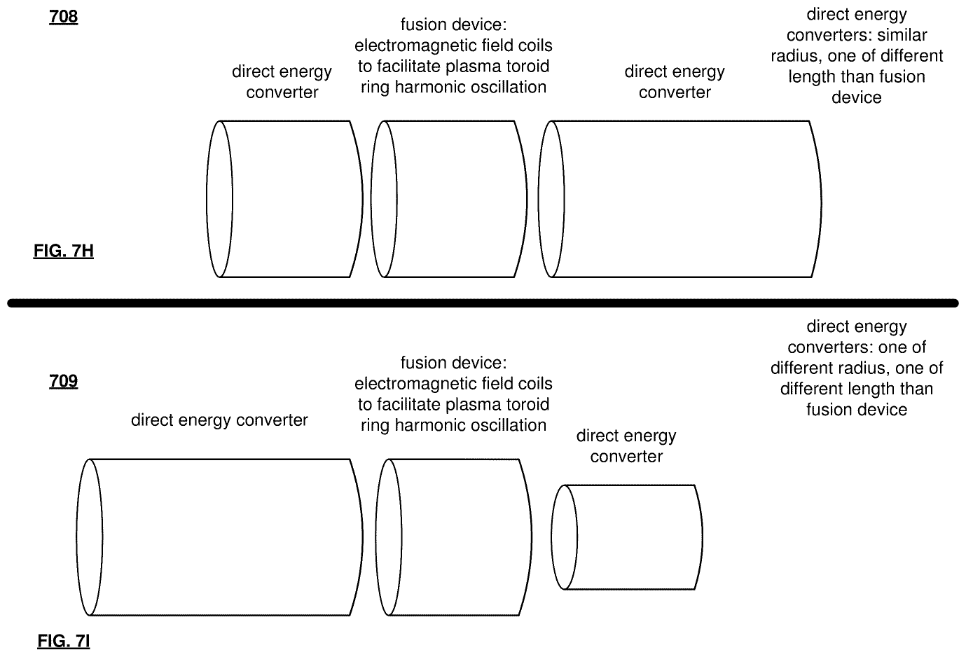

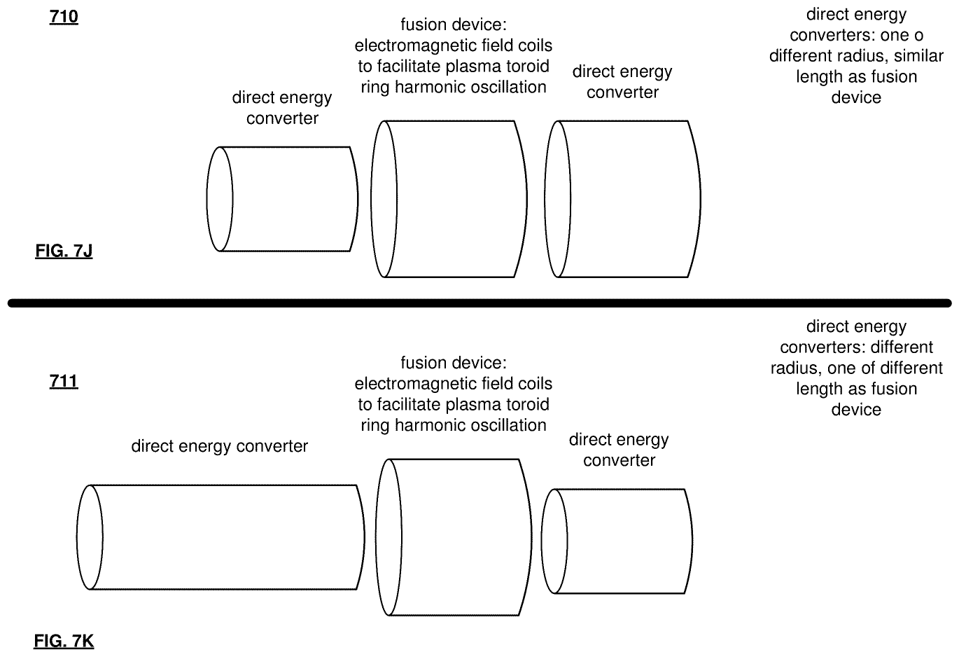

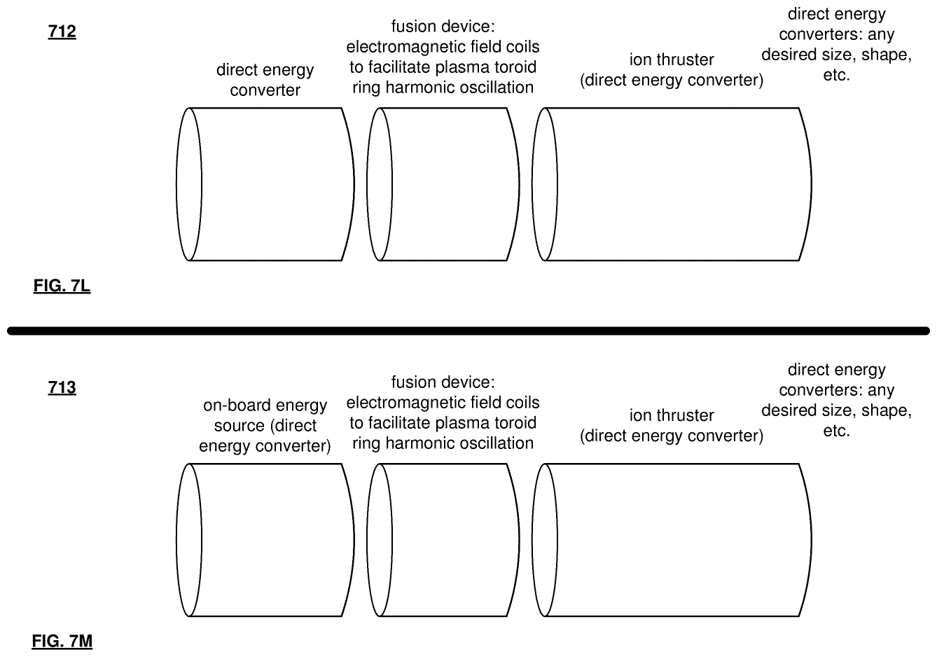

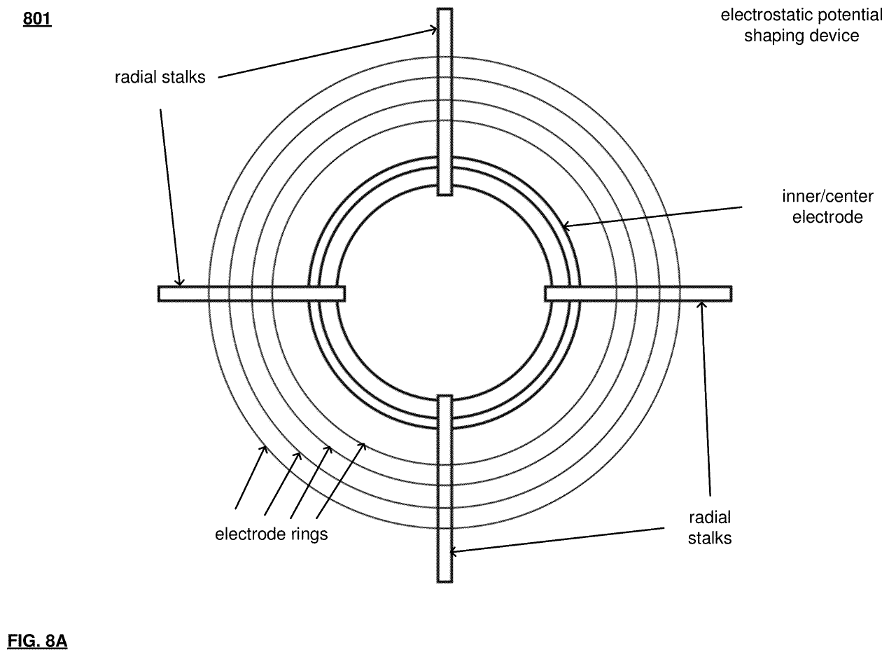

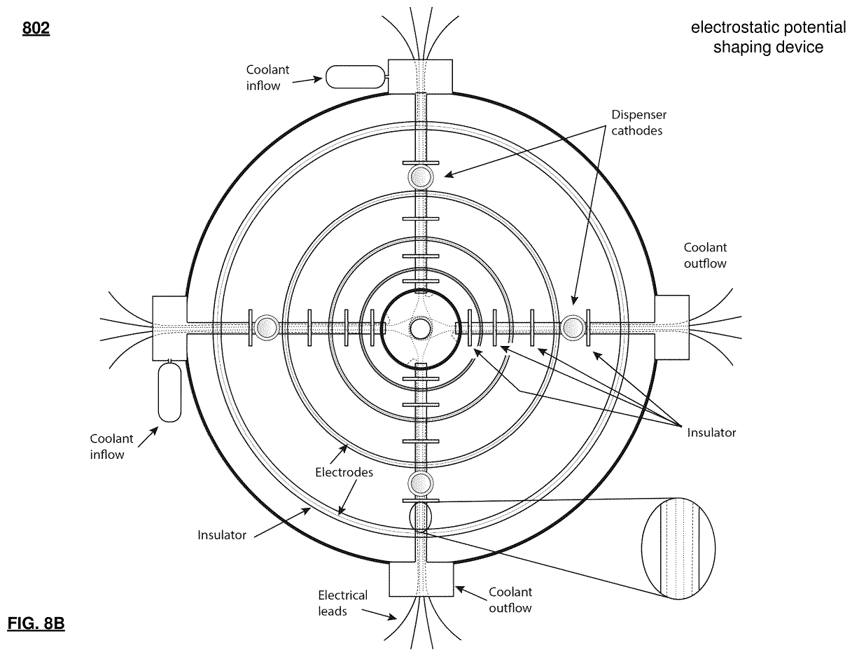

FIGS. 7A-7M are schematic block diagrams of various embodiments of a fusion device that is configured to operate with one or more direct energy converters located at each end of the fusion device.

In accordance with the nuclear fusion of Boron and Hydrogen as described herein, there are three high energy alpha particles, 3 ⁴He, produced. Consequently, energy conversion efficiencies can be greatly enhanced by placing direct energy converters on the ends of the advanced fuel oscillating fusion reactor (fusion device)) as shown by embodiment 701 of FIG. 7A. In certain situations, such direct energy converters require a strong axial magnetic field which precludes placing the field line electrodes on the outer vacuum chamber wall as is also described within <Reference 2>.

Generally speaking, the output from the fusion device is a stream of particles (e.g., high energy ⁴He particles). This stream of particles may be used in a variety of different manners. For example, the stream of particles itself may operate as the energy source for an ion thruster such as may be implemented within a spacecraft. In another example, the stream of particles is collected by one or more electrodes and operates as an electric current source. Generally speaking, a variety of types of direct energy converters may be used in conjunction with an advanced fuel oscillating fusion reactor (fusion device) as described herein.

FIGS. 7B-7M Show a variety of different examples by which Direct Energy converters may be implemented in conjunction with an advanced fuel oscillating fusion reactor (again, alternatively referred to as a fusion device). Many embodiments show 2 respective direct energy converters implemented at the ends of an advanced fuel oscillating fusion reactor (fusion device). In addition, note that an alternative embodiment includes only one direct energy converter implemented on one end of an advanced fuel oscillating fusion reactor (fusion device).

Referring to embodiment 702 of FIG. 7B, this diagram shows two (2) direct energy converters implemented at the ends of an advanced fuel oscillating fusion reactor (fusion device) that are substantially of the same size as the advanced fuel oscillating fusion reactor (fusion device). For example, the direct energy converters have substantially the same footprint as the advanced fuel oscillating fusion reactor (fusion device), in that, they have approximately the same diameter and length as the advanced fuel oscillating fusion reactor (fusion device).

Referring to embodiment 703 of FIG. 7C, this diagram shows two (2) direct energy converters implemented at the ends of an advanced fuel oscillating fusion reactor (fusion device) that are larger in size than the advanced fuel oscillating fusion reactor (fusion device). For example, each of the direct energy converters has approximately the same diameter, but each is longer than the advanced fuel oscillating fusion reactor (fusion device).

Referring to embodiment 704 of FIG. 7D, this diagram shows two (2) direct energy converters implemented at the ends of an advanced fuel oscillating fusion reactor (fusion device) that are larger in size than the advanced fuel oscillating fusion reactor (fusion device). For example, the direct energy converters have a larger diameter but approximately the same length as the advanced fuel oscillating fusion reactor (fusion device).

Referring to embodiment 705 of FIG. 7E, this diagram shows two (2) direct energy converters implemented at the ends of an advanced fuel oscillating fusion reactor (fusion device) that are larger in size than the advanced fuel oscillating fusion reactor (fusion device). For example, the direct energy converters have a larger diameter and a longer length than the advanced fuel oscillating fusion reactor (fusion device).

Referring to embodiment 706 of FIG. 7F, this diagram shows two (2) direct energy converters implemented on the ends of an advanced fuel oscillating fusion reactor (fusion device) that are smaller in size than the advanced fuel oscillating fusion reactor (fusion device). For example, the direct energy converters have a smaller diameter and approximately the same length as the advanced fuel oscillating fusion reactor (fusion device).

Referring to embodiment 707 of FIG. 7G, this diagram also shows two (2) direct energy converters implemented on the ends of an advanced fuel oscillating fusion reactor (fusion device). In this example, the direct energy converters have a smaller diameter and a longer length than the advanced fuel oscillating fusion reactor (fusion device).

Referring to embodiment 708 of FIG. 7H, this diagram also shows two (2) direct energy converters implemented on the ends of an advanced fuel oscillating fusion reactor (fusion device). In this example, the direct energy converters have approximately the same diameter as the advanced fuel oscillating fusion reactor (fusion device). One of the direct energy converters has approximately the same length as the advanced fuel oscillating fusion reactor (fusion device), and the other of the direct energy converters has a longer length than the advanced fuel oscillating fusion reactor (fusion device).

Referring to embodiment 709 of FIG. 7I, this diagram also shows two (2) direct energy converters implemented at the ends of an advanced fuel oscillating fusion reactor (fusion device). In this example, one of the direct energy converters has approximately the same diameter as the advanced fuel oscillating fusion reactor (fusion device) but a longer length than the advanced fuel oscillating fusion reactor (fusion device). The other of the direct energy converters has a smaller diameter than the advanced fuel oscillating fusion reactor (fusion device) and a shorter length than the advanced fuel oscillating fusion reactor (fusion device).

Referring to embodiment 710 of FIG. 7J, this diagram also shows two (2) direct energy converters implemented at the ends of an advanced fuel oscillating fusion reactor (fusion device). In this example, one of the direct energy converters has approximately the same diameter and approximately the same length as the advanced fuel oscillating fusion reactor (fusion device). The other of the direct energy converters has a smaller diameter than the advanced fuel oscillating fusion reactor (fusion device) and approximately the same length as the advanced fuel oscillating fusion reactor (fusion device).

Referring to embodiment 711 of FIG. 7K, this diagram also shows two (2) direct energy converters implemented at the ends of an advanced fuel oscillating fusion reactor (fusion device). In this example, one of the direct energy converters has a smaller diameter and approximately the same length as the advanced fuel oscillating fusion reactor (fusion device). The other of the direct energy converters has a smaller diameter and a longer length than the advanced fuel oscillating fusion reactor (fusion device).

Referring to embodiment 712 of FIG. 7L, this diagram also shows two (2) direct energy converters implemented at the ends of an advanced fuel oscillating fusion reactor (fusion device). In this example, the two direct energy converters have approximately the same diameter as the advanced fuel oscillating fusion reactor (fusion device), while one of the direct energy converters is approximately the same length as the ago, and the other of the direct energy converters is longer than the advanced fuel oscillating fusion reactor (fusion device). In this diagram, the longer of the direct energy converters is implemented as an ion thruster. The ion thruster is sourced directly by the stream of particles being emitted from the fusion device. Such an application of an ion thruster may include spacecraft.

Referring to embodiment 713 of FIG. 7M, this diagram also shows two (2) direct energy converters implemented at the ends of an advanced fuel oscillating fusion reactor (fusion device). In this example, the two direct energy converters have approximately the same diameter as the advanced fuel oscillating fusion reactor (fusion device), while one of the direct energy converters is approximately the same length as the ago, and the other of the direct energy converters is longer than the advanced fuel oscillating fusion reactor (fusion device). In this diagram, the longer of the direct energy converters is implemented as an ion thruster. Again, such an application of an ion thruster may include spacecraft. The ion thruster is sourced directly by the stream of particles being emitted from the fusion device. The shorter of the direct energy converters is implemented to serve as an on-board energy source. For example, the on-board energy source is implemented to provide energy to a variety of systems within a spacecraft. Examples of such systems may include water recovery systems, oxygen generators, pressurized oxygen tanks, solid fuel oxygen generators, life support systems, computer systems, communication systems, etc. as may be used within space exploration.

FIG. 8A-8C are schematic block diagrams of embodiments of an electrostatic potential shaping device.

Referring to embodiment 801 of FIG. 8A, an electrostatic potential shaping device includes a particular number of electrode rings. Generally speaking, the electrostatic potential shaping device is configured to grade the electric field, E, to have a desired shape within the fusion device that, in conjunction with the magnetic field, H or B, will help facilitate rigid rotor rotation of the plasma toroid rings within the fusion device.

This diagram includes four (4) rings that circumvent the inner electrode that extends along the center axis of the fusion device. Note that any desired number of electrode rings may be implemented (e.g., more than or less than four (4)).

The radial stalks carry the electrical leads to each of the rings as well as to the inner high voltage electrode. The electrical feeds for the internal coils also are contained in the radial stalks. They also carry coolant to cool the electrode rings, the inner/center electrode, and the internal electromagnetic coils. There is no central support included in embodiment 801. Another of the many differences and distinctions to the system of <Reference 2>, the central support used in <Reference 2> is eliminated by the novel design presented herein.

Referring to embodiment 802 of FIG. 8B, this diagram shows an alternative implementation of an electrostatic potential shaping device that includes a particular number of electrode rings. This diagram also includes four (4) rings that circumvent the inner electrode that extends along the center axis of the fusion device. Again, any desired number of electrode rings may be implemented (e.g., more than or less than four (4)). The electrode rings are shown as being included within insulator material within the vacuum chamber of the advanced fuel oscillating fusion reactor (fusion device). Also, insulators (e.g., ceramic structures) are implemented along the radial stalks of the electrostatic potential shaping device to shape the electric field generated by the electrode rings of electrostatic potential shaping device. And then, these insulators (e.g., ceramic structures) are shown as being implemented in between the inner/center electrode that extends along the center axis of the fusion device and the innermost ring electrode as well as between each of the other three respective ring electrodes. The insulators (e.g., ceramic structures) operate to ensure that there is no electric field gradient along the center axis of the device. The electric field, E, and the magnetic field, H or B, are normal to one another. The gradient of the magnetic field, H or B, is along the axial direction. It will vary based on location and the number of windings around the advanced fuel oscillating fusion reactor (fusion device). For example, in some instances, there are more windings on the two ends of the advanced fuel oscillating fusion reactor (fusion device). The gradient of the electric field, E, will be radial, and its intensity may change along the axial direction. For example, the magnitude of the electric field, E, may be different radially along different points along the axial direction of the cylinder of the advanced fuel oscillating fusion reactor (fusion device), but the electric field, E, will remain constant along the center axis of the cylinder of the advanced fuel oscillating fusion reactor (fusion device).

The top and the left radial stalks also carry coolant as shown by coolant inflow. The coolant travels through the top and the left radial stalks towards the inner/center electrode and are carried out through the bottom and right radial stocks as shown by coolant outflow and operate to cool the wires. In addition, the radial stalks carry wires to the electrode rings of the electrostatic potential shaping device. In certain examples, each stalk carries a respective wire to a respective one of the electrode rings. In other examples, one or more of the stalks include more than one wire. In even other examples, one or more of the stalks includes an electron source configured to emit electrons to ionize the plasma.

As described above, keeping viscous heating small also helps keep the ion and electron temperatures small. In an example of operation and implementation, this is achieved within the advanced fuel oscillating fusion reactor (fusion device) by making the poloidal rotation of the plasma as a rigid rotor (e.g., rigid rotor rotation of the plasma toroid rings within the fusion device). This also eliminates the possibility of the fluid-like Kelvin-Helmholtz mode (e.g., as described in <Reference 6>). This is achieved by tuning the electric and magnetic fields of the advanced fuel oscillating fusion reactor (fusion device) to achieve both harmonic oscillator behavior simultaneously with rigid rotor rotation of the plasma toroid rings therein. Including coils internal to the internal electrode (e.g., as in FIG. 6A) allows one to impose a radial field gradient on the axial magnetic field. In certain examples, it is desirable to cool these electromagnetic coils, so the internal electrode of the advanced fuel oscillating fusion reactor (fusion device) is implemented to be at atmospheric pressure (e.g., 1 atmosphere) and to have coolant flowing through it.

In an example of operation and implementation, this is achieved by the support structures such as shown by the electrostatic potential shaping devices of FIGS. 8A, 8B, and 8C that are configured physically to hold the inner electrode in place within the advanced fuel oscillating fusion reactor (fusion device). Note that this structure is placed outside of the potential well of the advanced fuel oscillating fusion reactor (fusion device), so that the oscillating plasma toroid rings do not come into contact with the electrostatic potential shaping devices.

In some examples, the structure of the electrostatic potential shaping device is implemented to hold off ~600 kV. In an example of operation and implementation, the insulators (e.g., ceramic structures) are implemented in between the inner/center electrode that extends along the center axis of the fusion device and the innermost ring electrode as well as between each of the other three respective ring electrodes. These insulators (e.g., ceramic structures) are configured to interrupt any potential arcs. The stalks are hollow so they can transport both coolant and electric signals (e.g., current and/or voltage signals) for the internal coils into the internal electrode. Note also that there are several conducting rings that allow the specification of potentials of the magnetic field surfaces. These rings allow for the radial profile of the electrostatic potential to be specified externally. Having the capability simultaneously to specify the radial gradients in both the electrostatic fields and the axial magnetic field provides sufficient control to both make the axial effective potential harmonic as well make the poloidal rotation a rigid rotor.

Again, note that the electrostatic potential shaping devices of FIGS. 8A, 8B, and 8C are placed outside of the effective potential well, so it will not directly contact the rotating plasma toroid rings. In addition, in some examples, note that dispenser cathodes are placed on the stalks to provide electrons to ionize the plasma. For example, one or both of the electrostatic potential shaping devices includes an electron source configured to provide electrons to ionize the plasma.

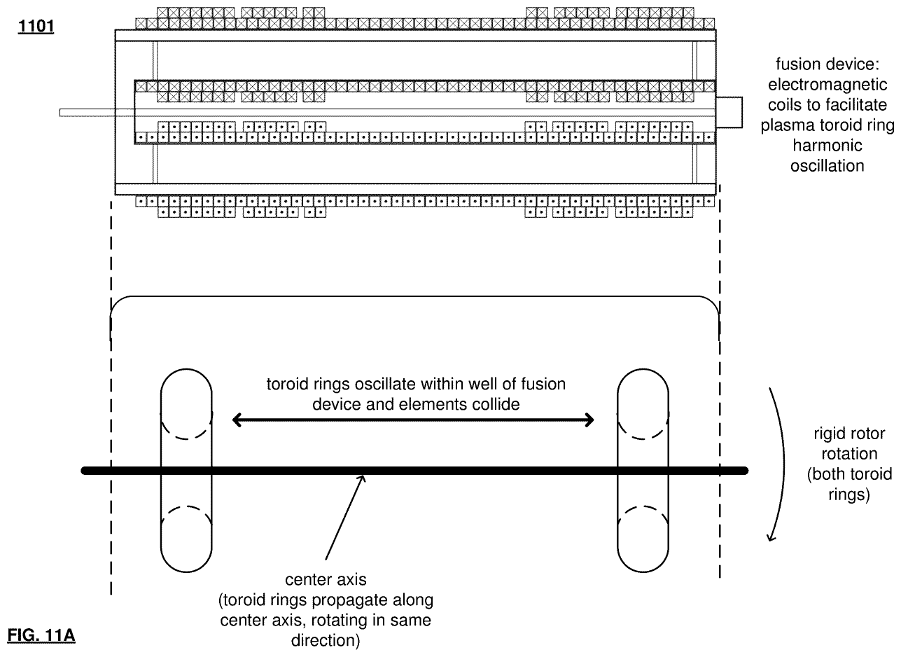

FIG. 9 is a schematic block diagram of an embodiment 900 of a toroid ring of a plasma implemented that is configured to undergo rigid rotor rotation. Generally speaking, a toroid is described as a surface of revolution with a hole in the middle in mathematics. Such a toroid ring (e.g., a circular toroid ring) may be characterized by a first radius, R, which corresponds to the radius of the overall shape, and this second radius, R, and that corresponds to the radius of the circular section. At the top middle of the diagram is the toroid side view 910. At the bottom left of the diagram are toroid side views 920 from a different perspective. At the bottom right of the diagram is a toroid cross-section view 930. In some examples, note that the plasma toroid rings as generated within an advanced fuel oscillating fusion reactor (fusion device) as described herein undergo rigid rotor rotation such that there is little or no shear flow within the circular section. For example, most or all of the elements within the circular toroid ring rotate at the same rate around the center axis that extends along the length of the advanced fuel oscillating fusion reactor (fusion device). Note also that some amount of shear flow is acceptable in some implementations (e.g., 1%, 5%, 10% or some other percentage of shear flow). For example, by reducing the shear flow, the thermal heating is consequentially reduced.

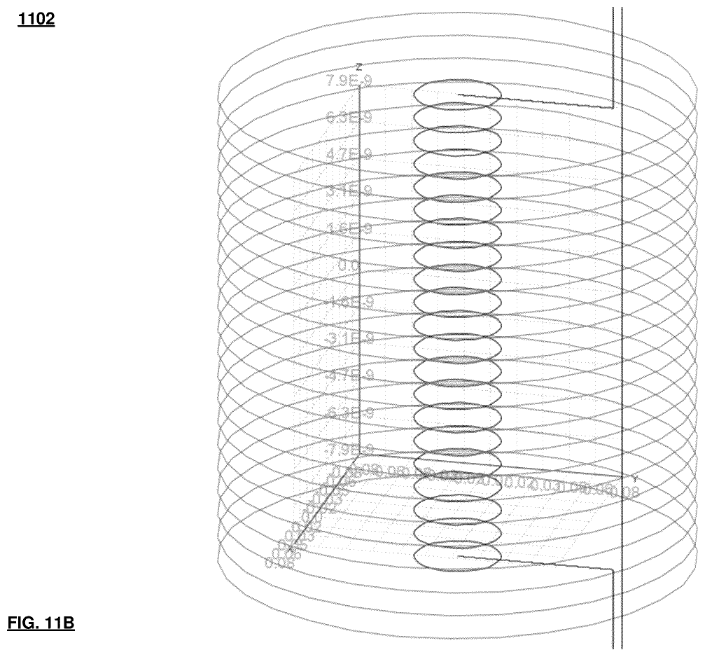

FIG. 10 is a schematic block diagram of an embodiment 1000 of two toroid rings of plasma that are configured to oscillate harmonically along the center axis of a fusion device while also undergoing rigid rotor rotation. This diagram shows how the toroid rings of plasma traverse back and forth along the axial direction of the advanced fuel oscillating fusion reactor (fusion device) while also undergoing rigid rotation as they propagate along that axis.

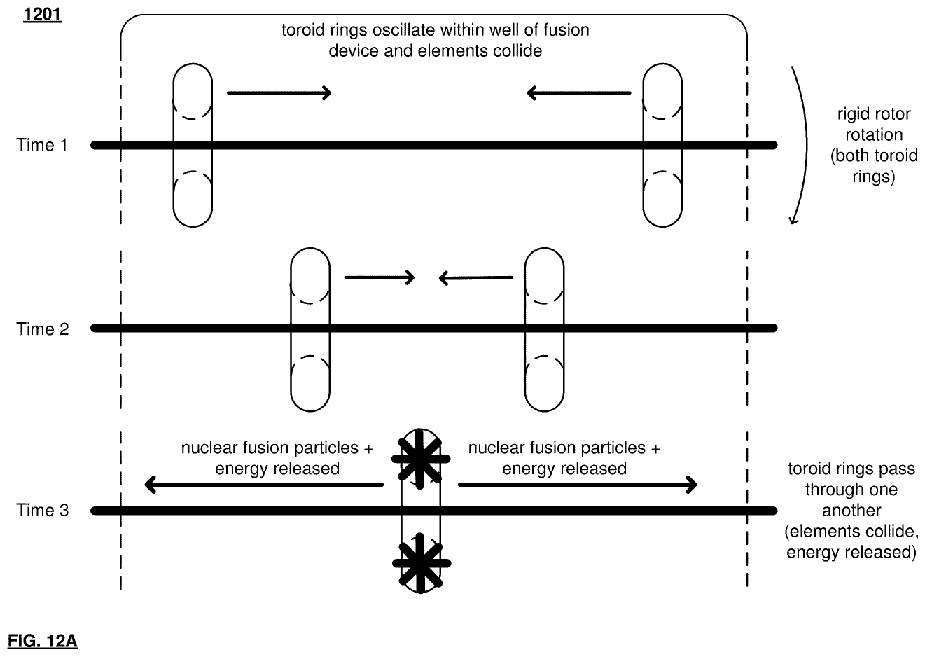

FIG. 11A is a schematic block diagram of an embodiment 1101 of two toroid rings of a plasma that are configured to oscillate harmonically along the center axis of a fusion device while also undergoing rigid rotor rotation in relation to a fusion device that includes magnetic field coils configured to facilitate harmonic oscillation of toroid rings of a plasma. This diagram is similar to the prior diagram but also includes, for reference, the advanced fuel oscillating fusion reactor (fusion device) (fusion device) that includes electromagnetic field coils to facilitate the plasma toroid ring harmonic oscillation. By appropriately driving the electromagnetic field coils, the plasma toroid rings are kept contained within the advanced fuel oscillating fusion reactor (fusion device) and are kept decoupled from the interior walls of the advanced fuel oscillating fusion reactor (fusion device).

From certain perspectives, the magnetic field of the advanced fuel oscillating fusion reactor (fusion device) shown in FIG. 6A has some similarities to a magnetic mirror, as described in <Reference 7> and <Reference 8>. One of several differences is that the advanced fuel oscillating fusion reactor (fusion device) has an inner and an outer electrode that cooperatively apply a largely radial electric field to the plasma. This causes a poloidal rotation as well as axial motion. This motion is described herein including with reference to FIGS. 9, 11A, and 12A-13D.

The magnetic and electric fields are applied using the electromagnetic coils in a manner such that the fields form an effective harmonic oscillator along the axial direction of the advanced fuel oscillating fusion reactor (fusion device). The plasma is driven so that the plasma divides into two plasma toroid rings. These rings are 180 degrees out of phase and periodically collide at z=0 in the axial direction (e.g., approximately near the center of the advanced fuel oscillating fusion reactor (fusion device)). The EXB drift (as described above) is large, so the collision velocity is large when the two plasma toroid rings collide. Nuclear fusion occurs during this collision. Again, this collision of the two plasma toroid rings is approximately near the center of the advanced fuel oscillating fusion reactor (fusion device).

An important property of an advanced fuel oscillating fusion reactor (fusion device) as described herein is that the well that operates to contain or confine the plasma has an effective harmonic potential for the particles therein. This is achieved by appropriate design of the layout of the electrodes and the electromagnetic coils of the advanced fuel oscillating fusion reactor (fusion device). This also involves the determination of the electrode voltages and the current in each of the electromagnetic coils to shape properly the electric field, E-field, and the magnetic field, H-field or B-field, to create a harmonic well that is effective to contain and confine the plasma therein.

In an example, a long solenoid operates as the electromagnetic coils and is wound around the cylindrical vacuum chamber of the advanced fuel oscillating fusion reactor (fusion device) and is configured to provide a basic uniform magnetic field, H-field or B-field, along the axis of the vacuum chamber. Outer trim coils are implemented outside the solenoid, and optionally also inner trim coils are implemented inside the vacuum chamber, are used to shape the basic uniform field into the harmonic potential to dictate the formation of the two plasma toroid rings and their oscillation along the axis of the vacuum chamber. Note also that the two plasma toroid rings undergo rigid rotor rotation as they are propagating back and forth along the axis of the vacuum chamber in accordance with this harmonic oscillation.

FIG. 11B is a diagram of an embodiment 1102 of inner and outer coils as can be implemented within a fusion device. For example, consider a coil layout such as described pictorially with reference to FIG. 11B, which shows possible locations for outer and inner coils. Generally speaking, a solenoid implemented using electromagnetic coils is configured to generate and shape the electric field, E-field, and the magnetic field, H-field or B-field, to create the harmonic well that is effective to contain and confine the plasma.

This involves the determination of the electric potential, V, the field strength of the base solenoid, Bᵤ, and the current, I_{c}, in each of the electromagnetic coils to produce a harmonic well. This may be performed in a number of different ways. In one example, an iterative process is performed based on derivation of a success criterion. For example, one example of a success criterion includes a function of those inputs (e.g., electric potential, V, the field strength of the base solenoid, Bᵤ, and the current, I_{c}, in each of the electromagnetic coils) and that also produces a figure-of-merit (FOM) value that tells how close the system is to achieving harmonicity due to the selected inputs. In one particular implementation, two such FOMs are used (which differ conceptually, but give the same answer) and are successfully used to find solutions. Note that multiple respective solutions may be found. In such a situation in which multiple solutions are found, one of the solutions may be chosen from among the many or multiple solutions based on any of a variety of considerations. Some examples of such considerations may include cost of implementation, ease of implementation, application context (e.g., terrestrial versus space applications), the environment in which the system is to be implemented (e.g., temperature, humidity, water vapor content, saltwater exposure, etc.), and/or designer preference or choice.

In one specific example, two different iterative schemes were developed to look for solutions in the parameter-space and to optimize a FOM to assist in finding a solution. In this particular example, solutions that were found in this manner are typically within 1 to 3 percent of harmonicity.

Then when a solution is found or selected from among a variety of possible solutions (e.g., such that the locations of and currents to be driven through the necessary electromagnetic trim coils are known), a plot of the magnetic variation down the center of the vacuum chamber of the advanced fuel oscillating fusion reactor (fusion device) is produced as an overall summary of the magnetic field produced by the solution. Also, a coil design method is produced for an electromagnetic trim coil design where the number of turns in a winding at each electromagnetic trim coil location is proportional to the total current looping at that particular location. Note that the number of electromagnetic coil windings need not necessarily be uniform along the entire length of the solenoid. That is to say, a greater number of electromagnetic coil windings may be included within one or more portions of the solenoid than in others. In one specific example, there are more electromagnetic coil windings at the respective ends of the solenoid to facilitate stronger fields within the harmonic well within the advanced fuel oscillating fusion reactor (fusion device).

Energy is supplied to the plasma toroid rings by driving the plasma at the axial resonance frequency. This can be done either electrostatically or magnetically. An embodiment of such an electromagnetic drive coil is described with respect to FIG. 6B. This configuration allows the plasma to be divided into two plasma toroid rings, and the plasma phase locks to the applied field. In one example, the driving frequency is twice the harmonic oscillator frequency, which is the highest resonant frequency of the governing Mathieu equation. For example, the governing Mathieu equation is described in <Reference 9>. This technique supplies directed (coherent) energy to the plasma rather than heating.

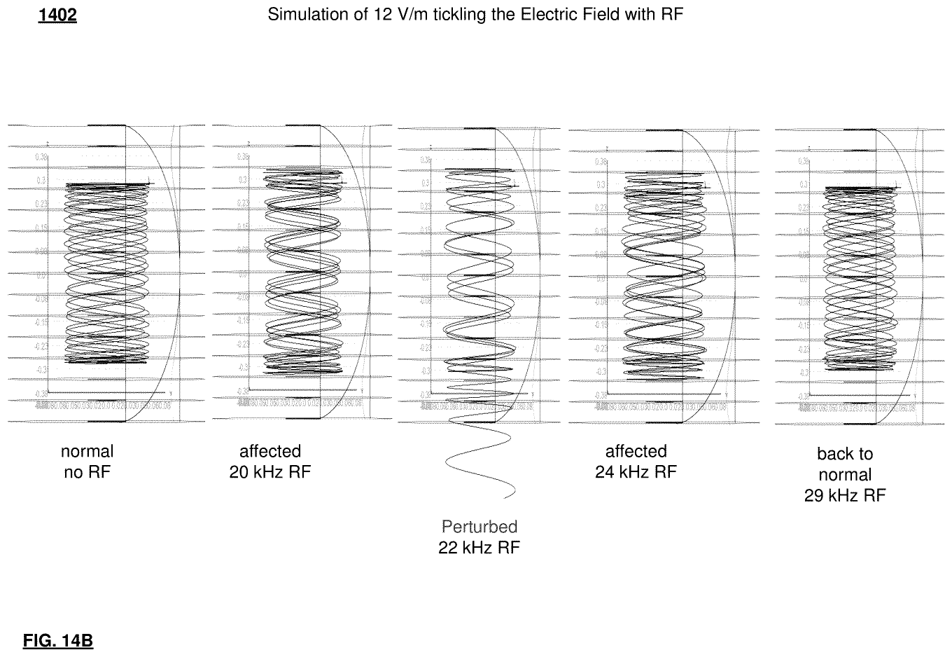

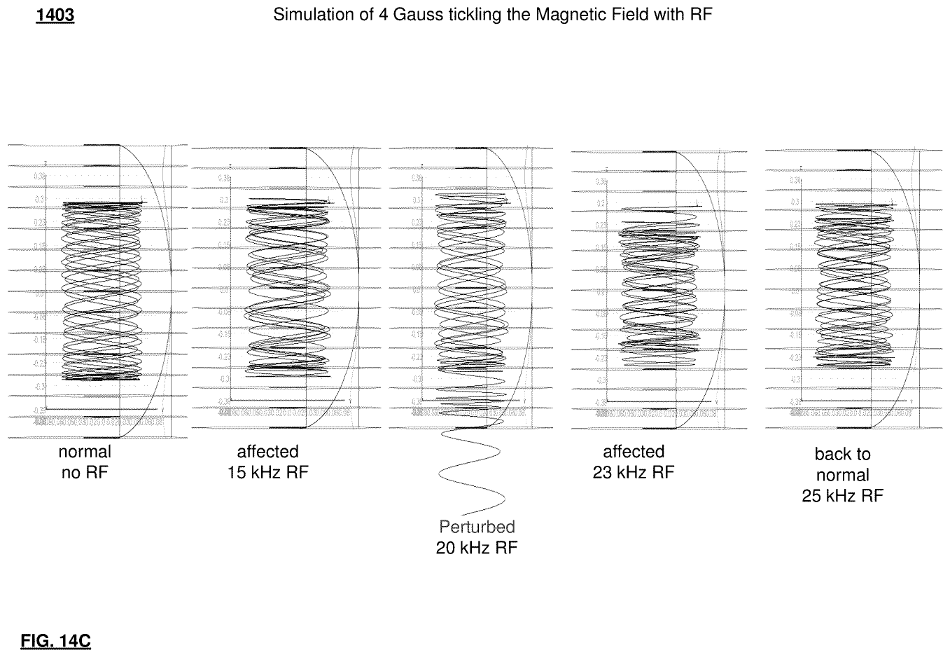

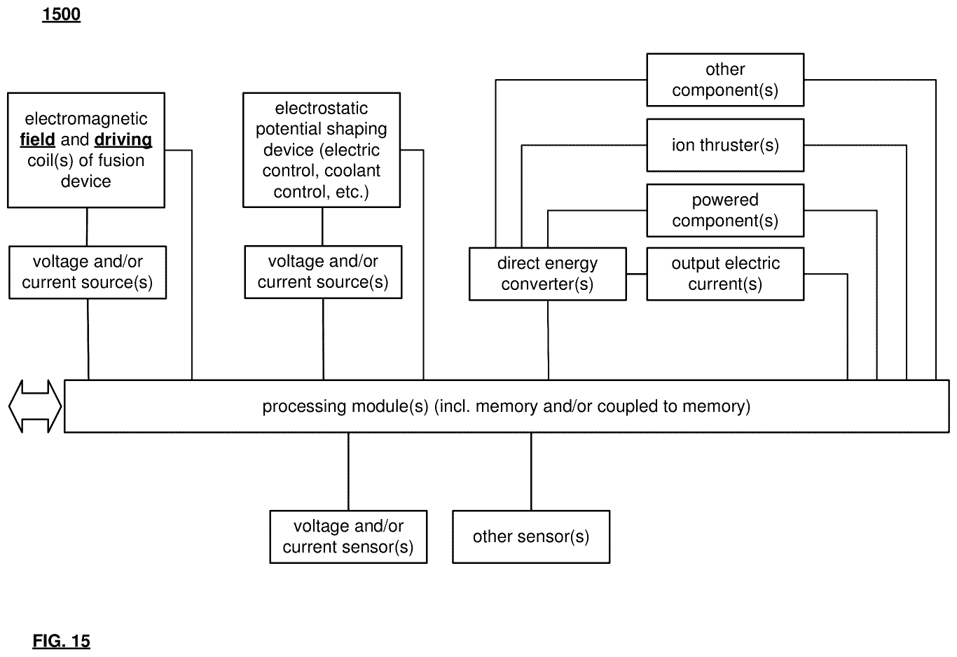

In addition, particle simulations have been performed that verify and confirm that the plasma can effectively be driven in this manner. An oscillating voltage of 6% the voltage applied to the inner electrode is enough to kick particles out of the harmonic well in just a couple of oscillation periods. Similarly, a 4% perturbation on the applied magnetic field compared to the static axial magnetic field is also enough to kick an ion out of the harmonic well. In one specific example, an RF signal having a frequency twice that of the frequency of the oscillating plasma facilitated a maximum effect. This result was expected based on the analyses and methods described above. FIG. 14A below shows an ion axially exiting the harmonic well due to the applied RF signal.

In order to turn a plasma device into a nuclear reactor/fusion device, it is necessary for the fusing plasma to produce more power than it takes to sustain the plasma. One energy loss mechanism includes radiation loss. Bremsstrahlung losses, P_{Br}, can be expressed as follows (e.g., as also described in <Reference 7>):

$${P}_{Br} = 5 \times {10}^{- 31} {n}^{2} {Z}_{eff} {T}_{e}^{1 / 2} watts / {cm}^{- 3}$$

where n is the electron density in cm⁻³, Tₑ is the electron temperature in keV, and Z_{eff} is the effective ion charge state. Note that as Tₑ gets small, the Bremsstrahlung power losses also get small. An advanced fuel oscillating fusion reactor (fusion device) as described herein substantially reduces or eliminates entirely Bremsstrahlung radiation as well as synchrotron radiation. These are significant improvements compared to conventional and prior art approaches to effectuate nuclear fusion providing many benefits including a significantly safer environment for personnel (e.g., fusion device operators and/or maintenance personnel, astronauts, etc.).

For example, synchrotron radiation losses, P_{c}, can be expressed as follows (e.g., as described in <Reference 10>):

$${P}_{c} ≅ 4.4 \times {10}^{- 28} {nB}^{2} {T}_{e} watts / {m}^{3}$$

Once again, these losses get small as Tₑ gets small. Consequently, one strategy to keep radiation losses small is to keep Tₑ as small as possible while still maintaining plasma ionization. That results in an electron temperature of a few electron volts (eV).

In some examples, both the electron temperature, Tₑ, and the ion temperature, Tᵢ, are approximately the same and both negligibly small (e.g., both approximately 0 eV or very close to 0 eV, such as less than 10 eV, less than 50 eV, less than 100 eV, or even other relatively low temperatures). Note that 10 eV is approximately the ionization energy for Hydrogen. Also, note that the fusion device can operate to effectuate nuclear fusion even at higher temperatures (e.g., electron temperature, Tₑ, and the ion temperature, Tᵢ, approximately up to or below 1245 eV in certain implementations).

Similarly, cross-field diffusion losses are driven by gradients in the electron and ion temperature and pressure of the plasma (e.g., as described in <Reference 5>. If not effectively controlled, cross-field diffusion can be a significant energy loss mechanism within a nuclear fusion device. For example, these cross-field diffusion losses are the dominant energy losses in conventional magnetic confinement fusion devices. These large gradients are one of the many deficiencies within the prior art that lead to the large sizes of conventional magnetic confinement fusion devices. Fusion devices that are dominated by cross-field transport losses generally try to reduce these losses by making the device large. Large size leads to smaller gradients and less transport. In contrast, an advanced fuel oscillating fusion reactor (fusion device) is configured to operate by keeping transport losses small by keeping the plasma temperatures and pressures small. Consequently, the advanced fuel oscillating fusion reactor (fusion device) does not have such size restrictions due to significantly reduced cross-field transport losses. The reduction or elimination of cross-field transport losses is a significant improvement compared to conventional and prior art approaches to effectuate nuclear fusion. In principle, such an advanced fuel oscillating fusion reactor (fusion device) can be made very small. This provides the capability of miniaturization of a nuclear fusion device that conventional and prior art approaches to nuclear fusion cannot provide.

However, if the electron and ion temperatures are small (e.g., relatively small in terms of plasma temperatures), then so are the electron and ion temperature and pressure gradients small (e.g., relatively small in terms of plasma electron and ion temperature and pressure gradients). This minimizes cross-field losses. The advanced fuel oscillating fusion reactor (fusion device) does not have these size restrictions of conventional magnetic confinement fusion devices. Consequently, keeping the electron and ion temperatures small makes both radiation losses and cross-field diffusion losses small. Consequently, such an advanced fuel oscillating fusion reactor (fusion device) can be implemented with a much smaller footprint compared to conventional magnetic confinement fusion devices. Generally speaking, such an advanced fuel oscillating fusion reactor (fusion device) can be very small in size while still operating to facilitate nuclear fusion. For example, such an advanced fuel oscillating fusion reactor (fusion device) can be implemented such that the entirety of it can fit within a vehicle or rail car for transport to any desired installation location. An advanced fuel oscillating fusion reactor (fusion device) having such a small footprint has great versatility in comparison to conventional magnetic confinement fusion devices. For example, consider that such an advanced fuel oscillating fusion reactor (fusion device) is implemented to have a footprint approximately the size of a commercial or residential backup electric power generator (e.g., that operates using gasoline, diesel fuel, natural gas, propane, or some other fuel source). Having an advanced fuel oscillating fusion reactor (fusion device) of such a small footprint provides the ability for it to be deployed in a wide variety of installation locations. Also, having such a small footprint greatly eases the challenge of transporting and shipping the fusion device to various installation locations.

In addition, keeping the electron and ion temperatures small has additional benefits and provides for much improved operation of an advanced fuel oscillating fusion reactor (fusion device) in comparison to prior conventional nuclear fusion devices. For example, if particles have a finite temperature that is parallel to the magnetic field, then some high energy particles can escape along the effective potential along the magnetic field lines. This is analogous to loss cone losses in magnetic mirrors. However, keeping the ion and electron temperatures small eliminates or significantly mitigates these undesired effects. Bad field line curvature effects of the magnetic field lines are obviated based on an advanced fuel oscillating fusion reactor (fusion device) as described herein.

Also, magnetic field lines are susceptible to interchange instabilities. These modes are driven by pressure gradients (e.g., as described in <Reference 11>). Eliminating these gradients by making the ion and electron temperatures small also eliminates the energy losses from these instabilities.

Several of these following diagrams describe pictorially the movement of two plasma toroid rings within an advanced fuel oscillating fusion reactor (fusion device). Again, appropriate electrical signals are driven through the electromagnetic coils implemented for the advanced fuel oscillating fusion reactor (fusion device) facilitate simple harmonic oscillation of the plasma toroid rings along the central axis of the advanced fuel oscillating fusion reactor (fusion device), while also facilitating rigid toroid rotation of those plasma toroid rings, to effectuate nuclear fusion of at least some of the elements contained within them. For example, the simple harmonic oscillation of the plasma toroid rings along the central axis of the advanced fuel oscillating fusion reactor (fusion device) may be viewed as undergoing sinusoidal oscillation back and forth along the device's central axis by translating along the central axis towards one end, then reversing direction and translating along the central axis towards the other end, and so on.

Generally speaking, the fusion reaction of the elements within the plasma toroid rings occurs approximately at the center point along the central axis of the advanced fuel oscillating fusion reactor (fusion device). In some examples, the shapes of the plasma toroid rings change as they undergo this simple harmonic oscillation within the potential well of the advanced fuel oscillating fusion reactor (fusion device) (e.g., larger in radius of the overall shape of the circular toroid ring, R, yet smaller in radius of the circular section of the circular toroid ring, r, towards the center point along the axis of the advanced fuel oscillating fusion reactor (fusion device)). For example, the shape of the plasma toroid rings remains substantially the same as they undergo this simple harmonic oscillation within the potential well of the advanced fuel oscillating fusion reactor (fusion device). Note that the potential well of the advanced fuel oscillating fusion reactor (fusion device) is implemented as a vacuum chamber or a near vacuum chamber. For example, a vacuum chamber is configured to generate the equivalent pressure therein of vacuum or near vacuum.

In an example of operation and implementation, a vacuum chamber is configured to generate a pressure or vacuum level therein at vacuum or near vacuum. Note that 1 Torr (sometimes capitalized as Torr in reference to its derivation from Evangelista Torricelli, or alternatively sometimes not capitalized as torr) is equivalent to 1/760^{th} of a standard atmosphere (atmospheric pressure on Earth, or 1 atm). As such, 1 atm equals 760 torr, and 1 torr equals 101325/760 pascals (Pa) or approximately 133.32 Pa. For example, a vacuum chamber is configured to generate vacuum or near vacuum in a range of 0 torr to 1 milli-torr, in a range of 0 torr to 10 milli-torr, in a range of 0 torr to 100 milli-torr, or in a range of 0 torr to some other measure of vacuum or near vacuum. Generally speaking, the vacuum chamber is configured to generate vacuum or near vacuum in a range of 0 torr to X milli-torr, where X is 10, 20, 50, 100, 200, 500, or some other measure of vacuum or near vacuum. Different measures of vacuum include rough vacuum from 760 torr down to 1 torr, medium vacuum from 1 torr to 1 milli-torr (10\hat{ }-3 torr), high vacuum from 1 milli-torr (10\hat{ }-3 torr) to 0.1 micro-torr (10\hat{ }-7 torr) and ultra-high vacuum below 0.1 micro-torr (10\hat{ }-7 torr). In an example of operation and implementation, a vacuum chamber is configured to generate vacuum or near vacuum in a range of 0 torr to 1 milli-torr or in a range of 0 torr to 10 milli-torr when facilitating fusion therein. In other examples of operation and implementation, a vacuum chamber is configured to generate vacuum or near vacuum in a range of 0 torr to 20 milli-torr or in a range of 0 torr to 50 milli-torr when facilitating fusion therein.

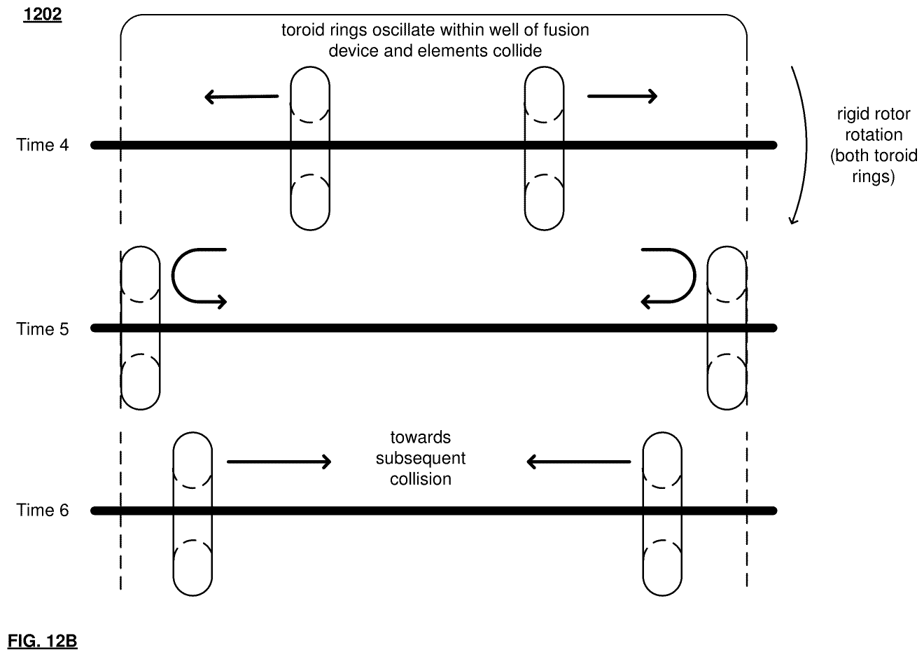

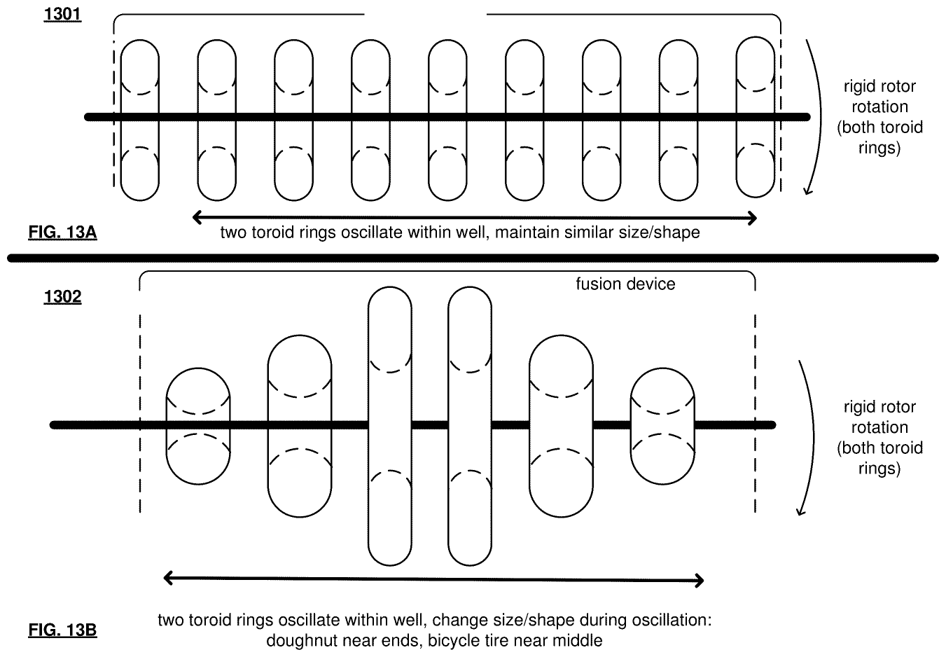

FIG. 12A-12B are schematic block diagrams of an embodiment of harmonic oscillation of two toroid rings of a plasma as a function of time.

Referring to embodiments 1201 and 1202 of FIG. 12A and FIG. 12B, the plasma toroid rings oscillate within the well of the fusion device, and the elements within those plasma toroid rings collide. Note that the plasma toroid rings also undergo rigid rotor rotation as they are translating back and forth in accordance with this simple harmonic oscillation along the central axis of the fusion device.

Referring to embodiment 1201 of FIG. 12A, at or during a first time (Time 1), two toroid plasma rings are shown approximately towards the ends of the potential well of the fusion device. As the appropriate electrical signals are driven through the electromagnetic coils of the fusion device, the two toroid rings propagate along the central axis of the fusion device towards one another while undergoing rigid rotor rotation.

At or during a second time (Time 2), that is subsequent to the first time (Time 1), the two toroid plasma rings are shown moving towards the center point of the potential well of the fusion device. As the appropriate electrical signals are driven through the electromagnetic coils of the fusion device, the two toroid rings continue to propagate along the central axis of the fusion device towards one another while undergoing rigid rotor rotation.

At or during a third time (Time 3), that is subsequent to the second time (Time 2), the two toroid plasma rings are shown colliding with one another approximately at the center point of the potential well of the fusion device. It is at this point of collision of the two plasma toroid rings that nuclear fusion occurs. At least some of the elements within each of the two plasma toroid rings collide with one another thereby generating nuclear fusion particles and a release of energy.

Referring to embodiment 1202 of FIG. 12A, at or during a fourth time (Time 4), that is subsequent to the third time (Time 3), the plasma toroid rings continue to oscillate within the potential well of the fusion device as they pass through one another after at least some nuclear fusion has occurred approximately at the center point along the central axis of the fusion device. The plasma toroid rings continue to translate in accordance with simple harmonic motion towards the respective ends of the fusion device.

At or during a fifth time (Time 5), that is subsequent to the fourth time (Time 4), the plasma toroid rings continue to oscillate within the potential well of the fusion device as they reach towards the respective ends of the fusion device and respectively reverse their directions of translation along the central axis of the fusion device. As described elsewhere herein, the operation of the fusion device including driving the appropriate electrical signals through the electromagnetic coils of the fusion device operate very effectively to ensure containment and confinement of the plasma within the potential well of the fusion device.

At or during a sixth time (Time 5), that is subsequent to the fifth time (Time 5), the plasma toroid rings continue to oscillate within the potential well of the fusion device as they once again propagate along the central axis of the fusion device towards approximately towards the center point of the central axis of the fusion device to undergo subsequent collision to facilitate subsequent nuclear fusion of at least some of the elements included within each of the plasma toroid rings. Once again, when the two plasma toroid rings collide with one another approximately at the center point of the central axis of the fusion device, there is generation of nuclear fusion particles and the release of energy.

As the advanced fuel oscillating fusion reactor (fusion device) continues operation, multiple and successive collisions of the two plasma toroid rings within the fusion device will continue to generate nuclear fusion particles and release energy. As also described within various examples and embodiments herein, these nuclear fusion particles and/or energy are harvested using various means such that power and/or energy may be realized from the outflow of nuclear fusion particles and energy from one or both of the two respective ends of the fusion device. For example, one or more direct energy converters is implemented at one or both of the two respective ends of the fusion device. In another example, an ion thruster is implemented at one of the ends of the fusion device. In yet another example, an ion thruster is implemented at one of the ends of the fusion device, and a direct energy converter is implemented at the other end of the fusion device. There are a variety of implementations in which various components maybe implemented at one or both of the respective ends of the fusion device to use directly or to harvest the power and/or energy that is realized from the outflow of nuclear fusion particles and energy from one or both of the two respective ends of the fusion device. For example, consider using a battery, a capacitor, a battery bank, a capacitor bank, or some other device that is configured to store electrical energy. By generating an electrical signal (e.g., an electrical current signal having a particular electrical voltage) that is based on the nuclear fusion particles and/or energy output from one or both of the respective ends of the fusion device and using that electrical signal to charge or charge up a battery, a capacitor, a battery bank, a capacitor bank, or some other device, then electrical energy could be stored therein for subsequent use. And even other examples, note that an electrical signal that is based on the nuclear fusion particles and/or energy output from one or both of the respective ends of the fusion device is used directly by one or more other devices such as an ion thruster, any electrically powered device, etc.

As mentioned above, the shapes of the plasma toroid rings change as they undergo this simple harmonic oscillation within the potential well of the advanced fuel oscillating fusion reactor (fusion device).

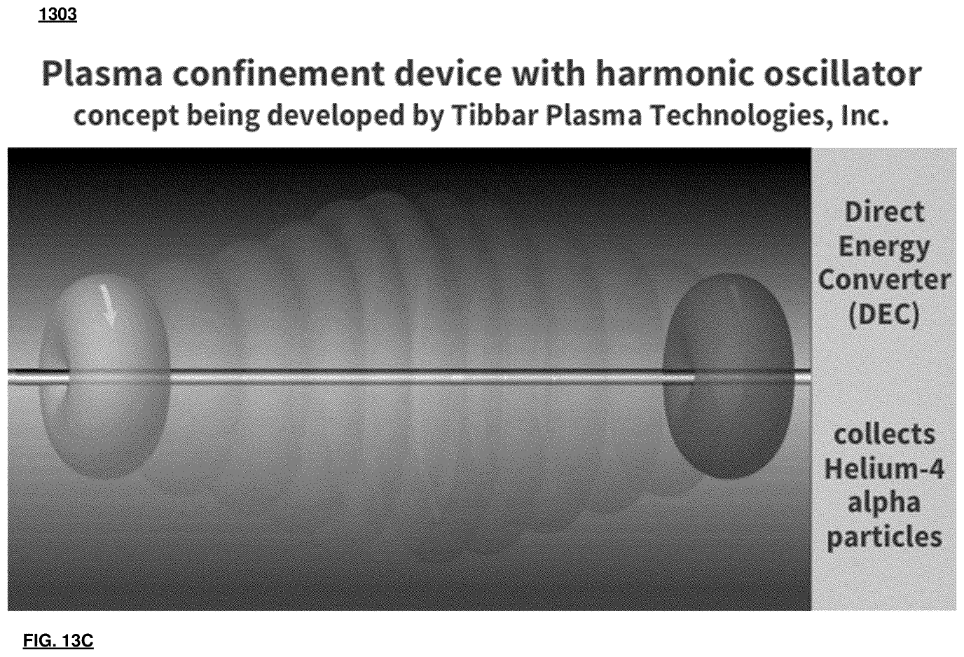

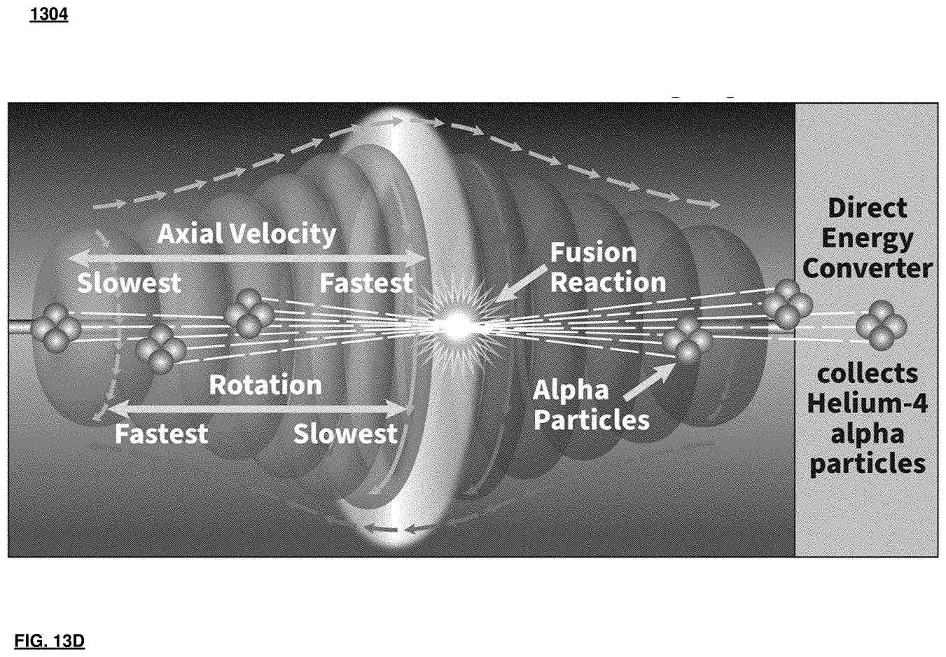

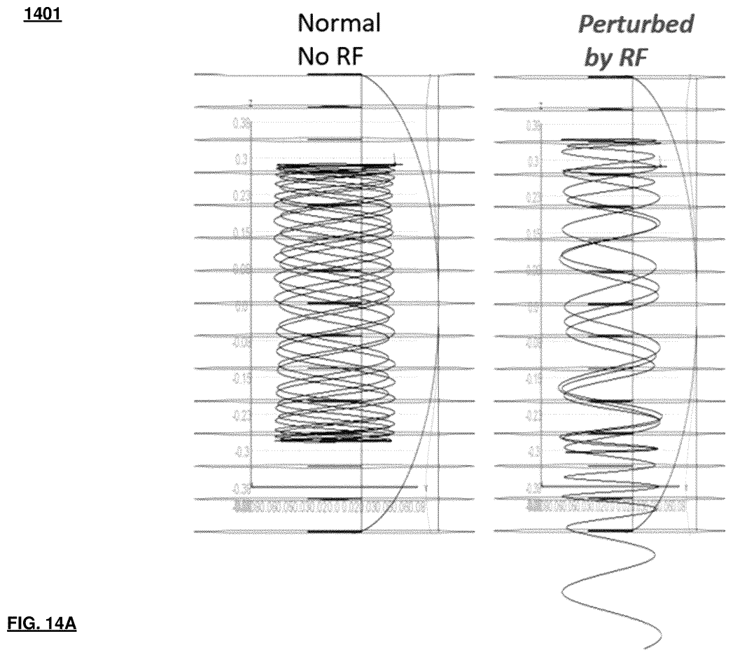

FIG. 13A is a schematic block diagram of an embodiment of two toroid rings of a plasma that are configured to oscillate harmonically along the center axis of a fusion device while substantially maintain their shape during the harmonic oscillation. Referring to embodiment 1301 of FIG. 13A, the shape of the plasma toroid rings remains substantially the same as they undergo this simple harmonic oscillation within the potential well of the advanced fuel oscillating fusion reactor (fusion device). For example, the radius of the overall shape of the circular toroid ring, R, and the circular section of the circular toroid ring, r, remain substantially the same as the plasma toroid rings as they undergo simple harmonic oscillation along the central axis of the advanced fuel oscillating fusion reactor (fusion device).

FIG. 13B is a schematic block diagram of an embodiment of two toroid rings of a plasma that are configured to oscillate harmonically along the center axis of a fusion device while changing their shape during the harmonic oscillation. Referring to embodiment 1302 of FIG. 13B, the shapes of the plasma toroid rings change as they undergo this simple harmonic oscillation within the potential well of the advanced fuel oscillating fusion reactor (fusion device). For example, the plasma toroid rings become larger in radius of the overall shape of the circular toroid ring, R, yet smaller in radius of the circular section of the circular toroid ring, r, towards the center point along the central axis of the advanced fuel oscillating fusion reactor (fusion device)). From certain perspectives, the two plasma toroid rings may be viewed as having a shape more similar to a doughnut when near the respective ends of the fusion device and having a shape more similar to a bicycle tire near the middle or approximately closer towards the center point of the central axis of the advanced fuel oscillating fusion reactor (fusion device).

FIG. 13C is a schematic block diagram of another embodiment of two toroid rings of a plasma that are configured to oscillate harmonically along the center axis of a fusion device while changing their shape during the harmonic oscillation. Referring to embodiment 1303 of FIG. 13C, this diagram has similarities to embodiment 1302 of FIG. 13B, in that, the plasma toroid rings change as they undergo this simple harmonic oscillation within the potential well of the advanced fuel oscillating fusion reactor (fusion device). In addition, to provide an alternative viewpoint to the reader, different colors are used for the two plasma toroid rings. For example, one of the plasma toroid rings is shown as a purple-type color, and the other plasma toroid rings is shown in a teal-type/aqua-type color.

FIG. 13D is a schematic block diagram of another embodiment of two toroid rings of a plasma that are configured to oscillate harmonically along the center axis of a fusion device while changing their shape during the harmonic oscillation. Referring to embodiment 1304 of FIG. 13D, this diagram has similarities to embodiment 1302 of FIG. 13B and embodiment 1303 of FIG. 13C, in that, the plasma toroid rings change as they undergo this simple harmonic oscillation within the potential well of the advanced fuel oscillating fusion reactor (fusion device). In addition, to provide an alternative viewpoint to the reader, different colors are used for the two plasma toroid rings. For example, one of the plasma toroid rings is shown as a purple-type color, and the other plasma toroid rings is shown in a teal-type/aqua-type color. In this example, the plasma toroid rings are shown as having a relatively fastest axial velocity towards approximately the center point of the fusion device. This is where collisions between elements within the two plasma toroid rings occur. Nuclear fusion occurs at approximately the center point of the fusion device when the plasma toroid rings are moving the fastest with respect to the central axis of the fusion device. The plasma toroid rings are shown as having a relatively slowest axial velocity towards the respective ends of the fusion device. For example, before the plasma toroid rings reverse direction at the respective ends of the fusion device, they are moving the slowest with respect to the central axis of the fusion device.

The plasma toroid rings are also shown as having a relatively fastest rotational velocity towards the respective ends of the fusion device. The plasma toroid rings are also shown as having a relatively slowest rotational velocity towards approximately the center point of the fusion device. Again, nuclear fusion occurs at approximately the center point of the fusion device when the plasma toroid rings are moving the fastest with respect to the central axis of the fusion device.

Note that the relatively fastest axial velocity and the relatively slowest rotational velocity occur at approximately the center point of the fusion device. Note also that the plasma toroid rings undergo rigid rotor rotation without shear flow of the elements within the plasma toroid rings. Also, the plasma toroid rings have approximately the same rotational velocity as they are respectively translating along the central axis of the fusion device. That is to say, the plasma toroid rings rotate at approximately the same velocity as one another within the fusion device.

In some examples, one or more direct energy converters are implemented at the respective ends of the fusion device to collect Helium-4 (⁴He) particles that are released from the ends of the fusion device in accordance with nuclear fusion that occurs when the two plasma toroid rings collide at approximately the center point of the fusion device.

FIG. 14A is a schematic block diagram of an embodiment of tickling the electric or magnetic field of a fusion device with radio frequency (RF) signals at twice the harmonic oscillator frequency. Note that RF signals as refenced herein correspond to signals within the frequency range of the RF spectrum (e.g., in a range of 20 or 30 kHz to 300 GHz or even from 2 to 3 kHz to 100 s or 1000 s of GHz). For certain implementations, this does not specifically include radio waves of such RF frequencies propagating through air or space. In alternative implementations, radio waves of such RF frequencies are used instead to tickle the electric or magnetic field of a fusion device. As shown in embodiment 1401, as also described above, when an RF signal is applied to the fusion device, it can facilitate the emission of ions from the fusion device. For example, when an RF signal is applied to the fusion device, it will add energy to the ions. In one specific example, when an RF signal having a frequency twice that of the frequency of the oscillating plasma is applied to the fusion device, a maximum effect is achieved (e.g., as described in <Reference 9>). This diagram shows an ion axially exiting the harmonic well of the fusion device due to the applied RF signal. In some examples, note that the RF signal may be applied to the electromagnetic driving coils that are implemented approximately the center point of the fusion device (e.g., such as described within embodiment 602 of FIG. 6B). In other examples, note that the RF signal may be applied to other electromagnetic coils of diffusion device such as those that are implemented externally to the fusion device and/or those that are implemented internally to the center electrode of the fusion device. For example, consider that an RF signal is superimposed on one or more other signals applied to the external electromagnetic coils and/or the internal external electromagnetic coils of the fusion device. In even other examples, an RF signal is applied separately to one or more other signals that are applied to the external electromagnetic coils and/or the internal external electromagnetic coils of the fusion device.

FIG. 14B is a schematic block diagram of an embodiment of tickling the electric field of a fusion device with radio frequency (RF) signals of various frequencies. Embodiment 1402 of this diagram shows various frequencies of RF signals that are applied in accordance with tickling of the electric field of the fusion device. For example, on the left-hand side of the diagram, no RF signal is applied.

Moving to the right in the diagram, RF signals having different respective frequencies are applied to tickle the electric field of the fusion device. For example, consider that the resonant frequency of the fusion device is approximately 11 kilohertz (kHz). That is to say, consider that the harmonic oscillator frequency of the fusion device, which is the highest resonant frequency of the governing Matthieu equation, is approximately 11 kHz (e.g., as described in <Reference 9>). In one particular example, the electric field of the fusion device is approximately 12 volts/m. Different respective RF signals having frequencies of 20 kHz, 22 kHz, 24 kHz, and 29 kHz are applied to the fusion device. When the RF signal has a frequency getting closer to twice the resonant frequency of the fusion device, such as the 20 kHz and 24 kHz RF signals, it can be seen that the particle orbits of the fusion device are affected. When the RF signal has a frequency that is twice the resonant frequency of the fusion device, such as 22 kHz, it can be seen that the particle orbits of the fusion device are significantly perturbed. As expected, particles gain energy and can be expelled when tickling of the electric field with an RF signal that is approximately twice the resident frequency of the fusion device.

FIG. 14C is a schematic block diagram of an embodiment of tickling the magnetic field of a fusion device with radio frequency (RF) signals of various frequencies. Embodiment 1403 of this diagram shows various frequencies of RF signals that are applied in accordance with tickling of the magnetic field of the fusion device. For example, on the left-hand side of the diagram, no RF signal is applied.

Moving to the right in the diagram, RF signals having different respective frequencies are applied to tickle the magnetic field of the fusion device. In one particular example, the magnetic field of the fusion device is approximately 4 Gauss. Different respective RF signals having frequencies of 15 kHz, 20 kHz, 22 23 kHz, and 25 kHz are applied to the fusion device. When the RF signal has a frequency getting closer to twice the resonant frequency of the fusion device, such as the 15 kHz and 23 kHz RF signals, it can be seen that the magnetic field of the fusion device is at least partially affected. When the RF signal has a frequency that is approximately twice the resonant frequency of the fusion device, such as 20 kHz, it can be seen that the particle orbits of the fusion device are significantly perturbed. As expected, particles are expelled when tickling of the magnetic field with an RF signal that is approximately twice the resident frequency of the fusion device.

An advanced fuel oscillating fusion reactor (fusion device) as described herein is configured to produce more energy than it consumes to operate. For a nuclear fusion device to be of practical use, it needs to produce more energy than it consumes to operate. The advanced fuel oscillating fusion reactor (fusion device) effectuates nuclear fusion by the collision of two plasma toroid rings along the central axis of its vacuum chamber as opposed to thermal motion of the plasma as is performed in many conventional nuclear fusion devices. This is a significant improvement when compared to conventional and prior art approaches to effectuate nuclear fusion. Typically, in conventional and prior art approaches to effectuate nuclear fusion, the nuclear fusion is effectuated via thermal effects (e.g., nuclear fusion effectuated from heat). In contrast, an advanced fuel oscillating fusion reactor (fusion device) as described herein is configured to effectuate nuclear fusion based on motion of the plasma toroid rings (e.g., and collision of elements therein).

As described above, the advanced fuel oscillating fusion reactor (fusion device) is configured to operate in harmonic oscillator potential (e.g., in accordance with simple harmonic motion), so that it always stays in thermodynamic equilibrium. In this case, collisions of elements within the plasma toroid rings only scatter into another part of the Maxwellian distribution and therefore they are irrelevant. In other words, the collisions of the elements within the plasma toroid rings operate only to scatter particles into another part of the distribution. This does not result in the generation of any undesired elements in accordance with the nuclear fusion process.

However, these Maxwellian distributions are in the moving coordinate frame of the plasma rings. For example, this is described with reference to FIG. 5. When the two plasma toroid rings collide, the plasma is not in a Maxwellian distribution in the center of mass frame, and collisions are therefore relevant. The plasma toroid rings will have Coulomb collisions, and the energy loss from the plasma toroid rings due to collisions will slow down their axial motion. In an example of operation and implementation, this energy is supplied by the axial pumping of the applied RF signal. Consequently, a fundamental limit on the energy gain is based on these collisions.

The fusion power produced per cubic centimeter (RR) is expressed as follows:

$$RR = 2 {n}_{p} {n}_{11 B} σ {v}_{rel} {E}_{fusion}$$

where nₚ is the proton density in one ring, n_{11B} is the ¹¹B density in one of the rings, σ is the nuclear fusion cross-section, and vᵣₑₗ is the relative velocity of the two rings (e.g., as described in <Reference 2>).

The factor of 2 accounts for the fact that the protons in the first plasma toroid ring fuse with the Boron-11 isotope, ¹¹B, in the second plasma toroid ring and the protons in the second ring fuse with the ¹¹B in the first plasma toroid ring. In certain examples, it can be assumed that the proton density, nₚ, and the ¹¹B density, n_{11B}, are the same in the two plasma toroid rings. Consequently, the following relationship holds:

$${n}_{p} = {n}_{11 B} = n / 2$$

where n is the electron density in cm⁻³. Since temperatures are low, ¹¹B is assumed to be singly ionized. E_{fusion} is the energy of the fusion reaction, which for p-¹¹B is 8.7 MeV or 1.39×10⁻⁵ ergs. The fusion cross-section peaks at about 1 barn (1×10⁻²⁴ cm²) (e.g., as described in <Reference 12>). This occurs for center-of-mass energies of about 600 keV. This leads to vᵣₑₗ of 1.073×10⁹ cm/sec.

Substituting these values into equation of fusion power produced per cubic centimeter (RR) above yields a measure of Fusion Power:

$$Fusion Power = 7.48 \times {10}^{- 21} {n}^{2} ergs / ( {cm}^{3} - sec ) .$$

For this analysis, the plasma toroid rings are assumed to interact by Coulomb collisions as the plasma toroid rings pass through one another. Coulomb scattering energy losses per cm³ for protons scattering off of electrons (which are the dominant energy loss term), dW/dt, are expressed as follows:

$$dW / dt = 1 / 2 {m}_{p} {n}_{p} {dv}_{rel}^{2} / dt = - {n}_{p} {v}_{ie} \text{.5} {m}_{p} {v}_{rel}^{2}$$

where vᵢₑ is the scattering frequency of protons off of electrons and is expressed as follows:

$${v}_{ie} = 1.7 \times {10}^{- 4} n {λ}_{ie} {T}_{e} {ε}^{- 5 / 2}$$

These Coulomb scattering energy losses are described in <Reference 5>, and the derivation of dW/dt is described in <Reference 13>.

Again, n is the electron density in cm⁻³, λᵢₑ is the Coulomb logarithm (about 10.25 for these plasmas) (e.g., as described in <Reference 5>), Tₑ is the electron energy in eV, and ε is the relative energy of the protons in the two rings in eV (6×10⁵ eV in our case). The above calculation is the energy loss from plasma toroid ring 1 protons colliding with plasma toroid ring 2 electrons, but there will also have losses from plasma toroid ring 2 protons colliding with plasma toroid ring 1 electrons, so the total Coulomb scattering energy losses per cm³, dWₜₒₜ/dt, is as follows:

$${dW}_{tot} / dt = 2 dW / dt = - {nv}_{ie} \text{.5} {m}_{p} {v}_{rel}^{2}$$

Substituting the scattering frequency of protons off of electrons, Vie, into total Coulomb scattering energy losses per cm³, dWₜₒₜ/dt, and including all of the plasma values provided above paragraph yields the following:

$${dW}_{tot} / dt = 6.007 \times {10}^{- 24} {n}^{2} {T}_{e}$$

Consequently, the energy gain, Q, such that Q=Fusion Power/dWₜₒₜ/dt is as follows:

$$Q = 1245 / {T}_{e}$$

where Tₑ is in eV.

Again, note that the analysis provided above is based on center-of-mass energies of about 600 keV. Note that different analyses and corresponding results would occur based on different energy parameters (e.g., different inputs such as different center-of-mass energies).

As such, for the operational parameters used above, the fusion production is higher than Coulomb scattering losses if the electron temperature is less than approximately 1245 eV. Consequently, such an advanced fuel oscillating fusion reactor (fusion device) as described herein does not suffer from the “Coulomb scattering beats fusion” argument that is often applicable with respect to Inertial Electrostatic Confinement Devices (e.g., as described within <Reference 14> and <Reference 15>).

Furthermore, the electron relative energy between the plasma toroid rings, E_{relelec}, is lower than the ion relative energy by the ratio of the electron mass to the proton mass.

$${E}_{relelec} = {m}_{e} / {m}_{p} 6 \times {10}^{5} = 327 eV$$

This means that the electron temperature can be comparable to the directed electron energy and still have Q>1. This helps mitigate the effects of streaming instabilities such as two-stream by Landau damping (e.g., as described within <Reference 7>.

FIG. 15 is a schematic block diagram of an embodiment of a system that includes one or more processing modules configured to facilitate operation of an advanced fuel oscillating fusion reactor. One or more processing modules, which may include integrated memory and/or be coupled to other memory is configured to execute one or more operations to nuclear fusion within an advanced fuel oscillating fusion reactor (fusion device). At least some of the memory, whether integrated memory and/or memory that is coupled to the one or more processing modules, stores operational instructions to be executed by the one or more processing modules.

In an example of operation and implementation, the one or more processing modules direct operation of one or more voltage and/or current sources that are coupled to electromagnetic coils slash windings of the fusion device. For example, one or more of the voltage and/or current sources are coupled to electromagnetic coils that are implemented to effectuate the field within the fusion device that facilitates the formation of the plasma toroid rings and their simple harmonic oscillation back and forth within the fusion device as well as rigid rotor rotation (e.g., as shown in FIG. 6A), and one or more other of the voltage and/or current sources are coupled to electromagnetic coils that are implemented to effectuate operation of the driving coil of the fusion device that is implemented approximately towards the center of the fusion device (e.g., as shown in FIG. 6B).

Some of the one or more voltage and/or current sources are configured to provide appropriate electrical signals to induce the electric and/or magnetic fields within the fusion device to facilitate operation of the fusion device. In addition, one or more other voltage and/or current sources are configured to provide appropriate electrical signals to control the electrostatic potential shaping device to facilitate the desired shaping of the electric field within the fusion device period.

In certain examples, note that the one or more processing modules is also configured to provide direct communication and/or control with the electromagnetic coils of the fusion device and the electrostatic potential shaping device. The one or more processing modules is configured to control operation of coolant that is provided within the electrostatic potential shaping device as desired in certain examples.

Note also that the one or more processing modules is configured to communicate with one or more direct energy converters that is implemented at one or both of the respective ends of the fusion device. The one or more direct energy converters is configured to provide any of a number of outputs as described herein. Some examples of such outputs include providing one or more output electric current, energy for one or more powered components, energy for one or more ion thrusters, and/or any one or more other components. Examples of such other components include terrestrial related loads, space exploration related loads, and/or generally any components that use or store energy.

Also, in certain examples, note that the one or more processing modules is configured to communicate with and receive information from one or more voltage sensors, current sensors, and/or generally any type of sensor that may be implemented within an advanced fuel oscillating fusion reactor (fusion device). For example, while the one or more processing modules is configured to control the operation of one or more voltage and/or current sources that is configured to provide electrical signals to various components within the fusion device, note that the one or more processing modules is also configured to receive information from sensors regarding the operation of the fusion device.

For example, the one or more voltage and/or current sensors, and/or one or more other sensors, is configured to provide information regarding the status of various components within the fusion device for use by the one or more processing modules. The one or more processing modules is configured to use this information to determine whether or not to adapt operation of diffusion device.

For example, consider that the information received by one or more processing modules indicates a desired operational status of the fusion device, then one or more processing modules is configured to continual operation of the fusion device in the same or ongoing manner. Alternatively, consider that the information received by the one or more processing modules indicates an undesired operational status of one or more components of the fusion device, then the one or more processing modules is configured to adapt or modify operation of the fusion device. As a specific example, consider that the amount of energy being emitted from one or both ends of the fusion device does not compare favorably to any desired amount of energy, then the one or more processing modules is configured to adapt or modify operation of one or more components of the fusion device to facilitate a change of the amount of energy being emitted from one or both ends of the fusion device. As another specific example, consider that one or more external electrical signals is deleteriously interfering with one or more of the electrical signals within the fusion device as determined by such information received from one or more sensors, then the one or more processing modules is configured to adapt or modify one or more characteristics of the electrical signals used within the fusion device. For example, this may involve changing the frequency of one or more electrical signals used within the fusion device so as to minimize or eliminate interference from one or more external electrical signals.

In some examples, the one or more processing modules is configured to control operation of one or more components of the fusion device and also to receive information regarding operational status and condition of one or more components of the fusion device. Note that the one or more processing modules is configured to receive user input and to operate in response to user input (e.g., via a man to machine interface such as a keyboard, computer display, etc.). Such an implementation may generally be described as a user directed or user-controlled operational mode.

In certain examples, the one or more processing modules is configured to control operation of one or more components of the fusion device and also to receive information regarding operational status and condition of one or more components of the fusion device in accordance with more predetermined and stored operational modes. For example, information regarding details of how various components within the fusion device are to be operated or driven to facilitate operation of the fusion device in accordance with one or more predetermined and stored operational modes is included within memory, and the one or more processing modules retrieves that information from the memory and appropriately directs operation of the components within the fusion device to effectuate one of the one or more predetermined and stored operational modes. Such an implementation may generally be described as an automated operational mode. In some examples, even when operating in accordance with an automated operational mode, note that the one or more processing modules is configured to receive user input that includes selection of which particular automated operational mode to use, and the one or more processing modules then facilitates operation of the fusion device in accordance with that user-selected automated operational mode. Consider an example in which the fusion device has a predetermined number of different automated operational modes to facilitate output of different respective amounts of energy. A user can then select which of those automated operational modes by which the fusion device is to operate to effectuate a desired amount of output energy.

Such as advanced fuel oscillating fusion reactor (fusion device) as described herein is a new plasma concept based on the production of fusion by two colliding plasma toroid rings. It utilizes a harmonic oscillator principle such that a harmonic oscillator maintains a plasma in thermodynamic equilibrium at all times. Because of this, collisions are irrelevant except when the plasma toroid rings collide. The device is linear and confinement of the plasma is provided by ExB drift motion resulting in an effective axial harmonic oscillator potential. In certain examples, axial energy is pumped into the system by oscillating either the electrodes or the magnetic field (or both) at an RF frequency that is approximately twice the harmonic oscillator frequency.

Also, the plasma is kept cold which significantly reduces radiation losses and transport losses both along the magnetic field and across the magnetic field in comparison to conventional prior art nuclear fusion devices. The temperature is kept small by keeping both ohmic heating and viscous heating small. The dominant heating effect is through the Coulomb collision when the plasma toroid rings collide. A net energy gain can be achieved based on the electron temperature being kept sufficiently low. High power can be achieved through density condensation which occurs naturally as the plasma cools.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

The preceding technical discussion may include a discussion regarding one or more of: an advantage(s) of a solution(s) to a problem(s), a benefit(s) of a solution(s) to a problem(s), an issue(s) giving rise to a problem(s), a market need(s) for a solution(s) to a problem(s), a value proposition(s) of a solution(s) to a problem(s), and/or the like. As may be applicable, the determining of an advantage(s) of a solution(s) to a problem(s), the determination of a benefit(s) of a solution(s) to a problem(s), the determination of an issue(s) giving rise to a problem(s), the determination of a market need(s) for solving a problem(s), the determination of a value proposition(s) for solving a problem(s), and/or the like can be deemed as one or more discoveries that constitute an invention and/or constitute part of an inventive step to create an invention.

While particular combinations of various functions and features of the one or more embodiments have been expressly described herein, other combinations of these features and functions are likewise possible. The present disclosure is not limited by the particular examples disclosed herein and expressly incorporates these other combinations.

### REFERENCES

1. Lawson, J. D. (December 1955). “Some Criteria for a Power Producing Thermonuclear Reactor,” Proceedings of the Physical Society, Section B. 70.
2. U.S. patent application Ser. No. 11/534,171, filed on Sep. 21, 2006, Publication No. US 2008-0226011 A1, inventor, Daniel C. Barnes, entitled, “Plasma centrifuge heat engine beam fusion reactor”.
3 X. Ribeyre, R. Capdessus, E. d'Humières, J. Wheeler and G. Mourou, “Multiscale study of high energy attosecond pulse interaction with matter and application to proton-Boron fusion,” (Dated: 27 Sep. 2021), available at <www.researchgate.net>.
4. R. A. Nebel, J. M. Finn, “Kinetic and Fluid Calculations for the Periodically Oscillating Plasma Sphere,” Physics of Plasmas 7, 839 (2000).
5. S. I. Braginskii, “Transport Processes in a Plasma,” Reviews of Plasma Physics, 1, edited by M. A. Leontovich, 1965.
6. “https://en.wikipedia.org/wiki/Kelvin % E2%80%93Helmholtz_instability”, available at <en.wikipedia.org>.
7. F. F. Chen, Introduction to Plasma Physics, Plenum Press, New York, 1974.
8. R. F. Post, Proc. of Second U.N. Int. Conf. on Peaceful Uses of Atomic Energy, Vol. 32, Paper A/Conf. 15/P/377, Geneva (1958), pp. 245-265.
9 M. Abramowitz and I. Stegun, Handbook of Mathema_cal Func_ons: with Formulas, Graphs, and Mathema_cal Tables, Dover Books (1965).
10. P. A. Naik, Encyclopedia of Spectroscopy and Spectrometry (Third Edition), Elsevier, 2017, Pages 725-734.
11. Kruskal, Martin; Schwarzschild, Martin (6 May 1954), “Some instabilities of a completely ionized plasma,” Proceedings of the Royal Society A. 223 (1154): 348-360.
12. “Proton-Boron-11 Fusion,” 2016 Jan. 11, available at “https://blog.naver.com/archizone21/220594610769”.
13. A. Beresnyak, 2023 NRL Plasma Formulary, p. 31, 32, available at “https://www.nrl.navy.mil/Portals/38/PDF%20Files/NRL_Plasma_Formulary_2023.pdf”
14. W. M. NEVINS, Phys. Plasmas, 2, 3804~1995!.
15. T. H. RIDER, Phys. Plasmas, 2, 1853~1995!.
16 D. C. Barnes and R. A. Nebel, Phys. Plasmas 5, 2498 (1998).

What is claimed is:

1. A fusion device comprising:
a vacuum chamber having a cylindrical shape and configured to contain a plasma having elements suitable for nuclear fusion;
a center electrode implemented axially within the vacuum chamber;
a first electromagnetic coil implemented around an exterior of the vacuum chamber;
a second electromagnetic coil implemented within an interior of the center electrode;
a direct energy converter implemented at an end of the vacuum chamber and configured to output energy based on nuclear fusion particles received from the vacuum chamber;
memory that stores operational instructions; and
one or more processing modules operably coupled to the memory and configured to execute the operational instructions to:
facilitate generation of vacuum or near vacuum within the vacuum chamber; and
facilitate driving of one or more electric current signals within the first electromagnetic coil and the second electromagnetic coil to generate a magnetic field within the vacuum chamber, wherein the magnetic field is configured to form the plasma into a plurality of plasma toroid rings around the center electrode and to effectuate the plurality of plasma toroid rings to undergo simple harmonic motion axially within the vacuum chamber such that at least some of the elements within the plurality of plasma toroid rings undergo collision and nuclear fusion to generate the nuclear fusion particles.

2. The fusion device of claim 1, wherein the magnetic field is further configured to facilitate rigid rotor rotation of the plurality of plasma toroid rings as the plurality of plasma toroid rings undergo simple harmonic motion axially within the vacuum chamber.

3. The fusion device of claim 1, wherein magnetic field within the vacuum chamber lies poloidally symmetric around the center electrode.

4. The fusion device of claim 1 further comprising:
one or more current sources configured to drive the one or more electric current signals within the first electromagnetic coil and the second electromagnetic coil to generate the magnetic field within the vacuum chamber.

5. The fusion device of claim 4, wherein the one or more processing modules further configured to execute the operational instructions to:
direct operation of the one or more current sources configured to drive the one or more electric current signals within the first electromagnetic coil and the second electromagnetic coil to generate the magnetic field within the vacuum chamber.

6. The fusion device of claim 1 further comprising:
an electron source configured to ionize the plasma.

7. The fusion device of claim 6, wherein the one or more processing modules further configured to execute the operational instructions to:
direct operation of the electron source to ionize the plasma.

8. The fusion device of claim 1 further comprising:
a plurality of electrostatic potential shaping devices respectively implemented proximate to ends of the vacuum chamber and configured to shape an electric field within the vacuum chamber.

9. The fusion device of claim 8, wherein the one or more processing modules further configured to execute the operational instructions to:
direct operation of the plurality of electrostatic potential shaping devices to shape the electric field within the vacuum chamber.

10. The fusion device of claim 8, wherein at least one of the plurality of electrostatic potential shaping devices includes an electron source configured to ionize the plasma.

11. The fusion device of claim 1, wherein the one or more processing modules further configured to execute the operational instructions to:
facilitate driving of the one or more electric current signals within the first electromagnetic coil and the second electromagnetic coil to generate the magnetic field within the vacuum chamber in a manner to decouple the plurality of plasma toroid rings from an interior wall of the vacuum chamber.

12. The fusion device of claim 11, wherein decoupling the plurality of plasma toroid rings from the interior wall of the vacuum chamber lowers temperature inside of the vacuum chamber and lowers or minimizes thermal fusion of the plurality of plasma toroid rings.

13. The fusion device of claim 1, wherein the vacuum or the near vacuum within the vacuum chamber is in a range of 0 torr to 1 milli-torr or a range of 0 torr to 10 milli-torr.

14. A fusion device comprising:
a vacuum chamber having a cylindrical shape and configured to contain a plasma having elements suitable for nuclear fusion;
a center electrode implemented axially within the vacuum chamber;
a first electromagnetic coil implemented around an exterior of the vacuum chamber;
a second electromagnetic coil implemented within an interior of the center electrode;
memory that stores operational instructions; and
one or more processing modules operably coupled to the memory and configured to execute the operational instructions to:
facilitate generation of vacuum or near vacuum within the vacuum chamber; and
facilitate driving of one or more electric current signals within the first electromagnetic coil and the second electromagnetic coil to generate a magnetic field within the vacuum chamber, wherein the magnetic field is configured to form the plasma into a plurality of plasma toroid rings around the center electrode and to effectuate the plurality of plasma toroid rings to undergo simple harmonic motion axially within the vacuum chamber such that at least some of the elements within the plurality of plasma toroid rings undergo collision and nuclear fusion to generate nuclear fusion particles.

15. The fusion device of claim 14, further comprising:
a direct energy converter implemented at an end of the vacuum chamber and configured to output energy based on nuclear fusion particles received from the vacuum chamber, wherein the output energy is configured to service at least one of an ion thruster, a power component, or a component that is configured to use an output electric current.

16. The fusion device of claim 14, wherein the one or more processing modules further configured to execute the operational instructions to:
facilitate driving of the one or more electric current signals within the first electromagnetic coil and the second electromagnetic coil to generate the magnetic field within the vacuum chamber in a manner to decouple the plurality of plasma toroid rings from an interior wall of the vacuum chamber.

17. The fusion device of claim 14, wherein the vacuum or the near vacuum within the vacuum chamber is in a range of 0 torr to 1 milli-torr or a range of 0 torr to 10 milli-torr.

18. A fusion device comprising:
a vacuum chamber having a cylindrical shape and configured to contain a plasma having elements suitable for nuclear fusion;
one or more electromagnetic coils associated with the vacuum chamber;
memory that stores operational instructions; and
one or more processing modules operably coupled to the memory and configured to execute the operational instructions to:
facilitate generation of vacuum or near vacuum within the vacuum chamber;
facilitate driving of one or more electric current signals within the one or more electromagnetic coils to generate a magnetic field within the vacuum chamber, wherein the magnetic field is configured to form the plasma into a plurality of plasma toroid rings around a center axis of the vacuum chamber and to effectuate the plurality of plasma toroid rings to undergo simple harmonic motion axially within the vacuum chamber such that at least some of the elements within the plurality of plasma toroid rings undergo collision and nuclear fusion to generate nuclear fusion particles; and
facilitate driving of the one or more electric current signals within the one or more electromagnetic coils to generate the magnetic field within the vacuum chamber in a manner to decouple the plurality of plasma toroid rings from an interior wall of the vacuum chamber.

19. The fusion device of claim 18, further comprising:
a direct energy converter implemented at an end of the vacuum chamber and configured to output energy based on nuclear fusion particles received from the vacuum chamber, wherein the output energy is configured to service at least one of an ion thruster, a power component, or a component that is configured to use an output electric current.

20. The fusion device of claim 18, wherein the vacuum or the near vacuum within the vacuum chamber is in a range of 0 torr to 1 milli-torr or a range of 0 torr to 10 milli-torr.
